(19) United States
(12) Patent Application Publication
(10) Pub. No.: US 2015/0371842 A1
(43) Pub. Date: Dec. 24, 2015

(54) SULFUR LAMP

(71) Applicant: Soo Yong PARK, Seoul, Seoul (KR)

(72) Inventor: Soo Yong PARK, Seoul (KR)

(21) Appl. No.: 14/764,390

(22) PCT Filed: Mar. 3, 2014
(86) PCT No.: PCT/US14/19826

§ 371 Date: Jul. 29, 2015

Related U.S. Application Data
(60) Provisional application No. 61/771,549, filed on Mar. 1, 2013.
(60) Provisional application No. 61/771,576, filed on Mar. 1, 2013.
(60) Provisional application No. 61/771,569, filed on Mar. 1, 2013.
(60) Provisional application No. 61/771,584, filed on Mar. 1, 2013.
(60) Provisional application No. 61/779,097, filed on Mar. 13, 2013.

(51) Int. Cl. H01J 65/04; H01J 23/38; G06F 17/50; G21F 7/03

(52) U.S. Cl. CPC H01J 65/044; G21F 7/03; H01J 23/38; G06F 17/50

(57) ABSTRACT

A sulfur lamp having low microwave leakage includes a structure made of a plurality of electrically conductive strips. The lamp cage is formed from respective halves removably joined together and configured to be resonant at the microwave frequency generated by the magnetron, in a mode that induces wall currents parallel to the joints formed by joining the halves together.

### CROSS-REFERENCE TO RELATED APPLICATIONS

This application claims priority to U.S. Provisional Application No. 61/771,549, filed Mar. 1, 2013, titled SULFUR LAMP CAGE HAVING A LOW MICROWAVE LEAKAGE, and to U.S. Provisional Application No. 61/771,569, filed Mar. 1, 2013, titled SPLIT TYPE UNIBODY SULFUR LAMP, and to U.S. Provisional Application No. 61/771,576, filed Mar. 1, 2013, titled COUPLERS FOR SULFUR LAMP, and to U.S. Provisional Application No. 61/779,097, filed Mar. 13, 2013, titled COUPLERS FOR SULFUR LAMP, and to U.S. Provisional Application No. 61/771,584, filed Mar. 1, 2013, titled SULFUR LAMP FOR STREET LIGHTING.

This application is related to PCT international application entitled “MAGNETRON” filed by the inventor hereof on even date herewith.

### FIELD OF THE INVENTION

The present invention relates to a lighting apparatus; more specifically, to a lamp.

### BACKGROUND

There are situations in which it is desirable to block microwaves and allow visible light to pass through. One example is a window in a microwave oven through which a user can view food being cooked without suffering adverse effects caused by microwaves from the oven. Another example is a sulfur lamp, which is a type of electrodeless lamp that is powered by microwaves, in which it is desirable to shine visible light into the environment of the lamp without leaking microwaves into the environment.

In a sulfur lamp, a small bulb, typically about the size of a golf ball and made of fused quartz, contains a small amount of sulfur in an atmosphere of low pressure argon. The lamp is driven by microwave energy typically generated by a magnetron. The microwaves first induce argon discharge, which in turn produces sulfur plasma. The sulfur plasma emits light in the visible spectrum very similar to sunlight.

The bulb is contained in a cage structure defining a cavity into which microwaves are directed and applied to the bulb. The cage is made of electrically conducting material that confines the microwaves. The cage wall fulfills two opposing purposes: to confine the microwaves to the inside of the cage; and to allow the visible light from the lamp to shine through the cage. A poorly designed cage may allow high leakage of the microwaves while giving poor transparency to the visible light. It is important to minimize microwave leakage because even a small amount of microwave leakage can adversely affect computers, communications, sensors, and other sensitive electronic devices, and can also have adverse effects on persons in close proximity. Therefore, microwave leakage is strictly regulated in most countries.

In the prior art, the cage is typically made of a thin metal mesh with many small holes. The holes must be small enough to acceptably prevent the escape of microwaves from the cage, but numerous enough to provide acceptable transparency to visible light shining through. Limitations on cage designs include the strength of the mesh material, the manufacturing difficulty, and the cost of production. Furthermore, the cage is exposed to high temperatures over the life of the lamp during its operation, which results in mesh deterioration and fatigue. Because of these limitations, prior art cages have generally unsatisfactory physical properties and microwave shielding characteristics for use in sulfur lamps.

An example of a prior art mesh type cage is shown in FIG. 1a. The cage is formed of a circular cylinder 100 made of a hexagonal mesh 110, with a disk of the same mesh covering the ends of the cylinder, 120. The cage encloses a microwave source such as a waveguide port, and a visible light source such as a sulfur lamp that produces light using the energy of the microwaves. The visible light transmission efficiency for this design can be shown to be about 86%. The microwave shield efficiency can be determined, for example, with the use of a waveguide test bed, as shown in FIG. 1b. In FIG. 1b, a known amount of microwave energy, 130, is directed into the waveguide, 140. The microwaves pass through a grid of the mesh material, 150, which blocks a portion of the microwaves. The remaining unblocked microwaves pass through the rest of the waveguide and are emitted at the other end, 160. The energy of the emitted microwaves can then be measured as various parameters are modified. For example, the microwave wavelength can be varied by varying the microwave frequency, to determine the effect of the wavelength on the blocking ability of the grid. The result is shown in FIG. 1c, which reveals increasing microwave energy leakage with increasing microwave frequency. The same result would be obtained with a cage made of such mesh material, such as the cage of FIG. 1a. In particular, as shown in FIG. 1c the mesh used in the cage of FIG. 1a and tested as in FIG. 1b has been determined to result in a leakage of about −36.0 dB at a microwave frequency of 2.45 GHz. This leakage level is considered too high for many purposes, including lighting applications. Therefore, products comprising such a mesh must often employ additional measures to mitigate microware leakage further.

Prior art sulfur lamp apparatuses have a plurality of sources of microwave leakage. FIG. 10 shows an exploded view of a prior art sulfur lamp apparatus. A cage, A, defining the microwave cavity is made of a thin mesh, and consequently the shielding efficiency is very poor. In order to reduce EMI, the lamp may be sealed within an outer case having an extra microwave absorbing coating and a microwave blocking gasket. The cage is joined to a base by a band type clamp B. Electrical contact resistance between the cage and the base caused by this type of joint also causes microwave leakage because it is difficult to apply enough pressure to the band to eliminate electrical resistance across the joint. Insufficient pressure produces a contact joint that results in microwave leakage attributable to interrupted flow across the joint of currents induced in the cage. In addition, as shown the waveguide connecting the lamp cage and the magnetron is generally a flat, rectangular parallelepiped constructed in two pieces, with one piece forming a bottom wall with two side walls, and the other piece forming a top wall. The top wall, basically just a metal plate, is typically attached to the side walls of the bottom piece with bolts, thus forming another joint with significant electrical contact resistance across the joint. This causes further microwave leakage as the wall current induced in the waveguide by the microwave energy passing through it flows across this joint. Although a flexible conducting gasket and electrically conducting glue may be applied, it is difficult to reduce the contact resistance enough to mitigate substantially all of the microwave leakage.

The magnetron is generally coupled to the waveguide with a flexible metal gasket C, similar to the type commonly used in a microwave oven, within which the magnetron antenna extends through hole D. This gasket results in a joint that also incurs significant microwave leakage. Although this type of joint may be acceptable for the short usage durations common in domestic microwave cooking, it is very difficult to reduce the contact resistance enough to reduce microwave leakage sufficiently for such an assembly to be used in lighting applications, such as street lighting. In addition, the high voltage leads at E to the cathode of the magnetron also provide a source of microwave leakage. In the prior art, a filter circuit is typically employed to block some of this leakage, and the whole is enclosed by a shield box F. However, this box is typically attached to the magnetron by a pressure fitting that is also a source of significant microwave leakage.

In order to mitigate some of the above mentioned problems, in the prior art the magnetron package may be enclosed within a metal shield box, which is again sealed in a manner similar to those referenced above, and consequently also incurs significant microwave leakage.

Thus in general, a sulfur lamp is an electrodeless lamp driven by microwave power. The microwave power is generated by a magnetron and coupled to a lamp cavity defined by a lamp cage and containing a sulfur bulb made of quartz. The coupler plays a very important role in matching the impedance of the magnetron to that of the lamp cavity. An improperly matched coupler not only degrades the performance of the lamp but also affect stable operation of the magnetron.

Furthermore, the impedance of the lamp cavity changes significantly between the time the lamp is first turned on and the time it is operating at peak light output. Before the lamp is turned on, no plasma exists inside the bulb and the impedance of the lamp has a very low resistive component. When the lamp is fully on, the sulfur in the bulb is in a plasma state and thus has a large resistive component, and the coupler should provide its best impedance matching. Therefore, the coupler cannot avoid a large impedance mismatch between the startup and full on states. Even so, the coupler must be designed to produce a strong enough electric field at startup to induce discharge in the bulb. It is also important to ensure the magnetron operates stably with this mismatched load because the magnetron is quite sensitive to such changes in the load impedance.

Prior art sulfur lamps employ a hole coupling using an electric dipole component as its dominant coupling mechanism. The coupling hole has a rather complex shape to achieve the coupling requirement. However, this coupler shows quite a large coupling loss because a strong field is concentrated at the coupler but not at the bulb.

The reason for the complex shape of this prior art coupling hole is to match the TE111 mode used in the prior art for the lamp cavity. This mode is a so called doubly degenerate mode, and as such is not the best mode to be used for a sulfur lamp. A degenerate mode is a resonant mode with two different field patterns available at the same resonant frequency. Consequently, it is difficult to achieve a stable match. Moreover, prior art couplers are generally too bulky to fit in existing fixtures for important applications such as street lighting.

The prior art provides high intensity lighting from many applications, including stadiums, warehouses, street lights, etc., each of which may have its own peculiarities regarding the needs of the lighting application, and the lighting implementation that satisfies those needs. For example, a street light is a raised light source generally placed next to and overhanging a road or walkway. Street lights are typically either turned on at a certain predetermined time every night, or comprise photocells to turn them on at dusk and off at dawn. Prior art street lighting typically uses high-intensity discharge lamps, such as high pressure sodium lamps or metal halide lamps. Such lamps have a luminous efficacy on the order of 75-150 lumens/watt, a nominal lifetime on the order of about 10,000-20,000 hours, and color rendering (a measure of spectrum continuity) and color temperature (that is, the hue of light produced by a black body when heated to a certain temperature) that distort the appearance of colors illuminated by the lamp when compared to sunlight. The sun produces light in a continuous spectrum that closely approximates light produced by a black body with an effective temperature of about 5,780 K.

It is desirable to have a lighting apparatus suitable for various lighting applications that can be installed in existing lighting fixtures and produce light with a similar distribution pattern without substantial modification of the fixtures, which has a luminous efficacy at least on the order of prior art lamps, that has a longer nominal life during which it requires little or no maintenance, and that provides color rendering and temperature more closely approximating that of sunlight, without producing any significant new undesirable effects.

Sulfur lamps driven by magnetrons do indeed provide light having the desired luminous efficacy and color characteristics. However, prior art sulfur lamp apparatus is too bulky to fit in many existing light fixtures for particular lamps in particular applications, have a sulfur bulb with a far shorter nominal lifetime than the magnetron they are coupled to, thus requiring maintenance that requires disassembly of the entire apparatus, and produce significant undesirable microwave leakage.

### SUMMARY

A sulfur lamp having low microwave leakage comprising a structure made of a plurality of electrically conductive strips. The lamp cage is formed from respective halves removably joined together and configured to be resonant at the microwave frequency generated by the magnetron, in a mode that induces wall currents parallel to the joints formed by joining the halves together.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate disclosed embodiments and/or aspects and, together with the description, serve to explain the principles of the invention, the scope of which is determined by the claims.

In the drawings:

FIG. 1A shows a cage that is made of a mesh in the form of a thin metal sheet having many small holes.

FIG. 1B shows a waveguide model to determine the leakage of microwaves through the mesh of FIG. 1A.

FIG. 1C is a graph showing the microwave transmission attenuation of the mesh of FIG. 1A as a function of the microwave frequency.

FIG. 2A illustrates a wall current flow for a circular cylindrical cage in the TM010 mode.

FIG. 2B illustrates a wall current flow for a rectangular parallelepiped cage in the TE101 mode.

FIG. 3A shows a louver structure for use with a circular cylindrical cage in the TE101 mode.

FIG. 3B shows a louver structure for use with a rectangular cage in the TE101 mode.

FIG. 4A shows a waveguide model to determine the leakage of microwaves through the louver structure of FIG. 3B.

FIG. 4B is a graph showing the microwave leakage rate as a function of the depth of the louver of FIG. 3A.

FIG. 4C shows a light transmission rate and a leakage rate as a function of the gap parameter.

FIG. 5 shows a ring shaped rib structure added to the louver structure of FIG. 3A to improve its structural stability.

FIG. 6 shows a radial louver replacing the top of the structure of FIG. 5.

FIG. 7A shows an embodiment of a cage with a hybrid wall that includes the louver structure of FIG. 3A combined with a solid metal top and bottom walls, formed in two pieces. As shown, a microwave coupling hole can be included in one of the solid walls.

FIG. 7B shows an embodiment of a cage formed in two pieces, with a hybrid wall that includes the louver structure of FIG. 3B combined with solid metal top and bottom walls, one of which has a microwave coupling hole.

FIG. 8A shows a cage with a wall having a deep honeycomb structure.

FIG. 8B illustrates forming the honeycomb structure in the cage of FIG. 8A. As shown, the honeycomb can be made of many flat strips folded and joined together in a manner that provides a joint with low electrical resistance, such as by soldering, brazing, or welding.

FIG. 8C shows a waveguide model to determine the leakage rate of the honeycomb structure of FIG. 8A, formed as shown in FIG. 8B.

FIG. 8D is a graph showing the microwave leakage rate as a function of the depth of the honeycomb structure of FIG. 8A.

FIG. 9A shows a rectangular panel-type viewing window having a microwave-blocking honeycomb structure that may be used in a microwave oven.

FIG. 9B shows a circular panel-type viewing window having a microwave-blocking honeycomb structure.

FIG. 10 is an exploded view of a prior art sulfur lamp apparatus that in operation produces significant microwave leakage.

FIGS. 11A, 11B, and 11C illustrate an exemplary split microwave enclosure construction taking advantage of the current flows illustrated in FIGS. 2A and 2B in assembly A and assembly B, respectively, of the figures. FIG. 11A is an exploded view of the apparatus, including an antenna-type coupler to convey microwave energy from the magnetron to the sulfur lamp. FIG. 11B shows the components of FIG. 11A fully assembled. FIG. 11C is an exploded view of a different exemplary apparatus that uses a waveguide-type coupler to convey the microwave energy from the magnetron to the sulfur lamp.

FIG. 12 is an exploded view of a prior art sulfur lamp apparatus that in operation produces significant microwave leakage.

FIG. 13A shows a sulfur lamp apparatus with an E-coupler with a matching post.

FIG. 13B shows the matching character using the coupler of FIG. 13A before and after discharge.

FIG. 13C shows the field distribution using the coupler of FIG. 13A before and after discharge.

FIG. 13D shows the field strength at the bulb center using the coupler of FIG. 13A before and after discharge.

FIG. 14A shows a sulfur lamp apparatus with a post coupler with a matching post.

FIG. 14B shows the matching character using the coupler of FIG. 14A before and after discharge.

FIG. 14C shows the field distribution using the coupler of FIG. 14A before and after discharge.

FIG. 14D shows the field strength at the bulb center using the coupler of FIG. 14A before and after discharge.

FIG. 15A shows a sulfur lamp apparatus with an H-coupler.

FIG. 15B shows the matching character using the coupler of FIG. 15A before and after discharge.

FIG. 15C shows the field distribution using the coupler of FIG. 15A before and after discharge.

FIG. 15D shows the field strength at the bulb center using the coupler of FIG. 15A before and after discharge.

FIG. 16A shows an exemplary embodiment of a sulfur lamp apparatus, one that is suitable for street lighting, sized to fit in existing street lighting fixtures and producing a light distribution pattern similar to prior art street light lamps.

FIG. 16B shows an exploded view of the apparatus of FIG. 16A.

FIG. 16C shows a cross sectional view of the apparatus of FIG. 16A.

FIG. 16D shows the line of uninterrupted light for a point source at the center of the bulb for two exemplary embodiments.

FIG. 17 shows an embodiment having a circular cylindrical louvered lamp cage.

FIG. 18 shows an embodiment having a chamfered louvered cage.

FIG. 19 shows an embodiment having an ellipsoid louvered cage.

FIG. 20A shows a magnetron with long antenna enclosed in a ceramic enclosure.

FIGS. 20B and 20C show a narrow magnetic flux-return circuit, in assembled and exploded views, respectively.

FIGS. 20D and 20E show a narrow conductive cooling block, in assembled and exploded views, respectively.

### DETAILED DESCRIPTION

It is to be understood that the figures and descriptions provided herein may have been simplified to illustrate elements that are relevant for a clear understanding of the present invention, while eliminating, for the purpose of clarity, other elements found in typical systems and methods in the art. Those of ordinary skill in the art may recognize that other elements and/or steps may be desirable and/or necessary to implement the devices, systems, and methods described herein. However, because such elements and steps are well known in the art, and because they do not facilitate a better understanding of the present invention, a discussion of such elements and steps may not be provided herein. The present disclosure is deemed to inherently include all such elements, variations, and modifications to the disclosed elements and methods that would be known to those of ordinary skill in the pertinent art.

Louver-Type Construction

Microwaves in a cage comprising an electrically conductive wall have a specific distribution of the electromagnetic field, which at a resonant frequency is called a resonant mode. This mode of resonance is accompanied by a wall current flow with a distribution specific to the mode. In order to confine the microwaves to the inside of the cage, the wall must comprise a good electric conducting material such as metal. If there are gaps, holes, or joints with high electrical resistance in the wall, microwave energy can leak through them, although the microwaves may be blocked or attenuated in the process.

However, in a lamp such as a sulfur lamp, it is necessary for a cage containing the light source to have unobstructed areas such as gaps or holes for the visible light to shine through. A louver type of cage wall can be used both to block microwaves and to allow visible light to shine through. By choosing an appropriate cavity shape, resonance mode, and louver arrangement, such a cage provides both low microwave leakage and high visible light transmission.

A particularly useful resonance mode that arises in the circular cylindrical structure illustrated in FIG. 2A is the so-called TM010 mode. The dimensions of a component having such a structure can be selected so that only the TM010 mode arises for a given microwave frequency. In this mode, the currents along the side wall induced by the microwaves are all parallel to the central axis of the cylinder. A rectangular cavity defined by a rectangular parallelepiped component can be similarly configured so that a resonance mode called the TE101 mode arises for a given microwave frequency that shares certain characteristics of the TM010 mode, including induced wall currents parallel to a central axis from a top to a bottom of the component, as illustrated in FIG. 2B. Thus, these two different cage shapes experience analogous modes that produce similar wall current flows.

For these modes, a cage with a louver-type sidewall comprising thin conducting strips may be configured so that the strips are parallel to the induced wall current, with surfaces that are parallel to visible rays from a light source placed within the cavity defined by the wall, as illustrated in FIGS. 3A and 3B. As such, the louvers comprise a plurality of thin electrically conductive strips 310 lined up with the current flows and arranged to cast a minimal shadow to visible light passing through the wall. The strips are preferably coupled at their top and bottom to electrically conductive covers 320 and 330, respectively, that define the top and bottom of the cavity defined thereby. When a properly designed cage contains both a visible light source and a microwave source, the louver structure allows visible light to shine through while at the same time suppressing microwave leakage to a safe level well within legal limits.

In designing the louver structure, the louver strips are preferably made as thin as practicable while still providing the mechanical strength needed for a particular application, and to promote ease of manufacture and to resist deterioration.

The ability of the louver structure to suppress microwave leakage is determined at least in part by the effective depth of the louver, which is defined by the width of the strips from which it is made. In the gaps between adjacent louver strips, microwaves attenuate exponentially to a level that is related to the width of the strips and the size of the gaps between them. Visible light transmission, however, is essentially unaffected by the width of the strips or the size of the gaps between them, being affected only by the thickness and orientation of the strips, which cast a shadow. Therefore, by judiciously selecting the louver strip thickness, orientation, width, and gap size, microwave leakage can be suppressed very effectively while maintaining good light transmission.

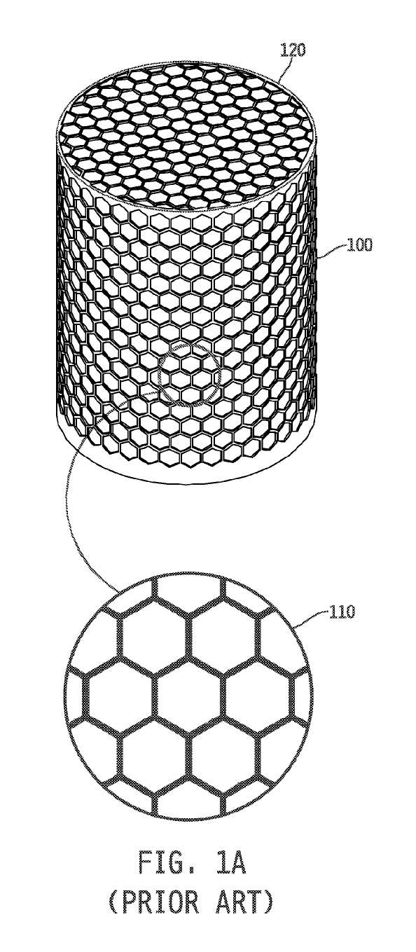

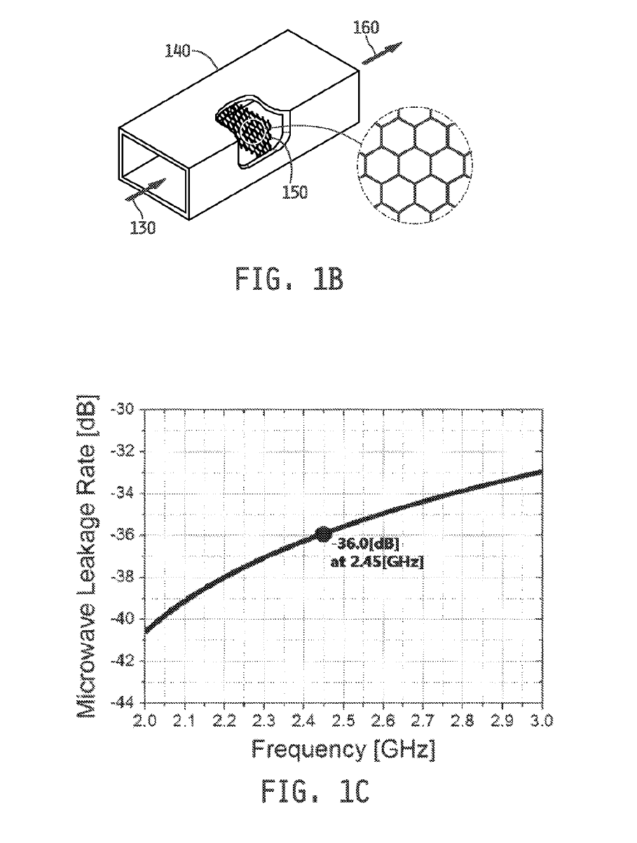

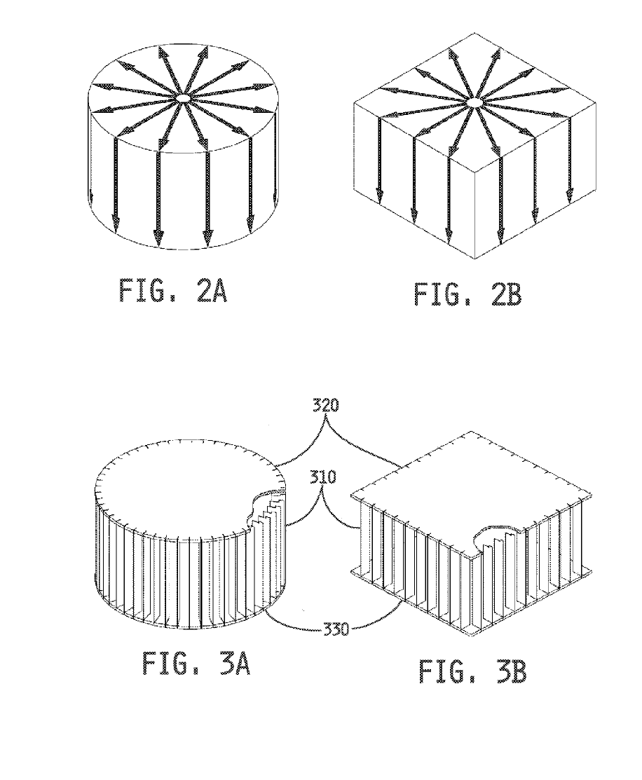

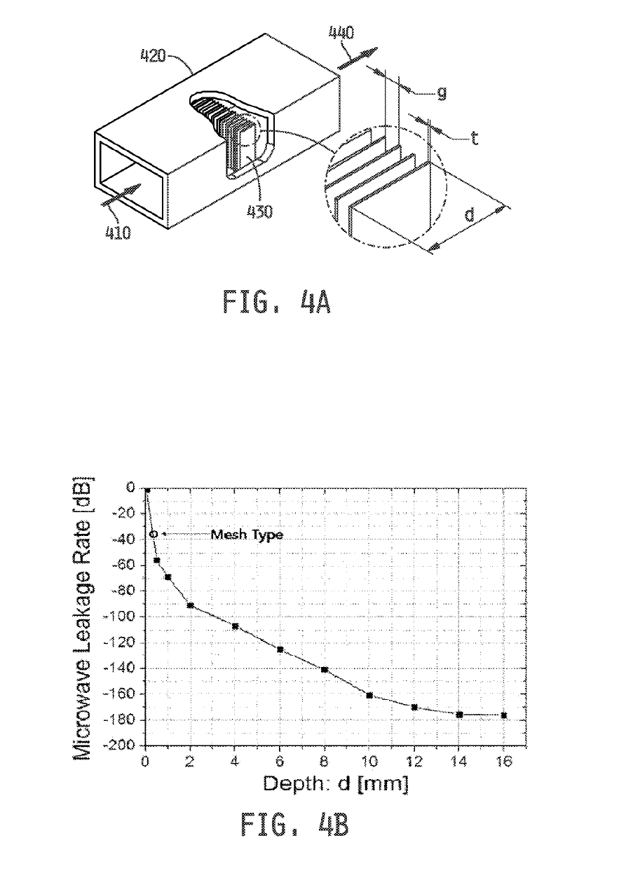

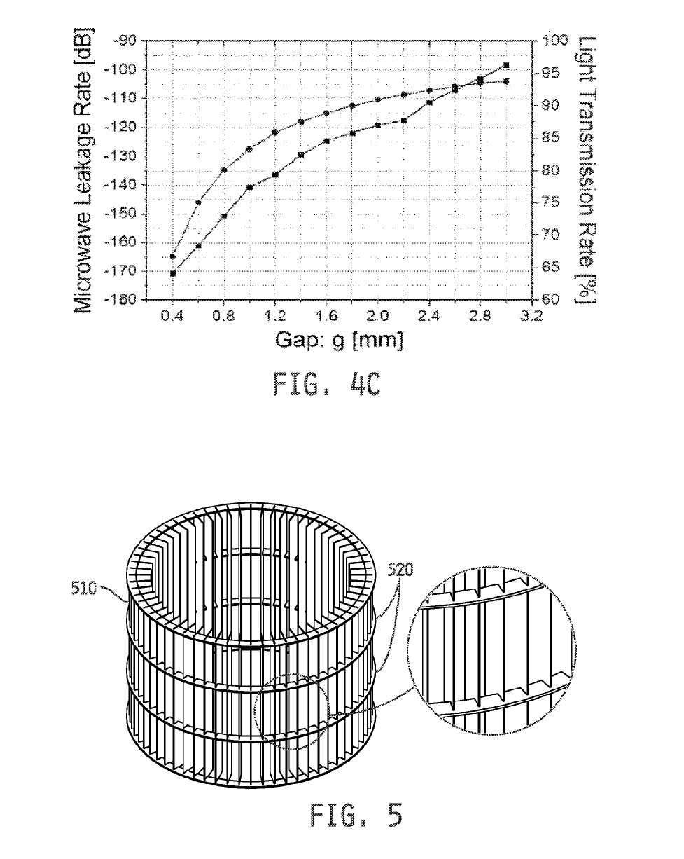

The microwave leakage rate can be estimated using a waveguide model, such as the illustrative waveguide model shown in FIG. 4A. In the figure, a known amount of microwave energy, 410, is directed into the waveguide, 420. The microwaves pass through the louver material, 430, which blocks a portion of the microwaves. The remaining unblocked microwaves pass through the rest of the waveguide and are emitted at the other end, 440. The energy of the emitted microwaves can then be measured as various parameters are modified. The microwave leakage from louvers constructed of strips having particular dimensions can then be estimated. For example, as shown in FIG. 4B, at a constant microwave frequency of about 2.45 GHz, a constant gap between strips, and a constant strip thickness, the leakage rate can be seen to vary with the depth of the louver. Other parameters may be similarly varied and the resulting microwave leakage measured. In embodiments, louvers can be constructed that effectively pass visible light and effectively block microwaves at 2.45 GHz using a plurality of uniform strips, each having a thickness t of between 0.05 mm and 3.0 mm, and preferably about 0.1 mm; a gap g between adjacent strips of between 1.0 mm and 3.0 mm, and preferably about 2.0 mm; and a depth d of each strip of between about 1.0 mm and 10.0 mm, and preferably about 8.0 mm and thus forming a wall with a thickness of about 8.0 mm. As can be seen from FIG. 4B, the louver structure can reduce the microwaves leaking from the cavity by adjusting only the depth d, to many orders of magnitude below that of the prior art mesh structure of FIG. 1A which is indicated by the small circular datapoint at about −36 dB.

Different results are obtained by varying different parameters. For example, FIG. 4C illustrates the microwave leakage rate (square data points) and light transmission rate (round data points) obtained while varying only the gap distance g between louver strips, holding other parameters constant. The degree to which the louvers allow visible light to pass through can be determined based on the geometry of the cage, the placement of the visible light source within it, and the dimensions, spacing, and orientation of the louvers. The degree to which the louvers attenuate microwave leakage can again be determined using the waveguide model shown in FIG. 4A, but this time varying only the gap distance. The resulting microwave leakage rate and light transmission rate as a function only of the gap, keeping constant the thickness of the strips, the depth of the louver, and the microwave frequency, is shown in FIG. 4C.

For a given microwave frequency and predetermined microwave leakage, the louver strip thickness and width and the gap between adjacent strips may be chosen by taking into account considerations such as the light transmission provided, the cost of manufacture including the cost of materials, the strength of the structure, and the like.

In embodiments, horizontal rings or the like can be added to the vertical louver structure to improve the strength and stability of the structure, without adversely affecting the microwave suppression and visible light transmission characteristics of the structure. One such embodiment is illustrated in FIG. 5. In the figure, a cylindrical louver structure comprises a plurality of vertical strips 510 reinforced with rings 520.

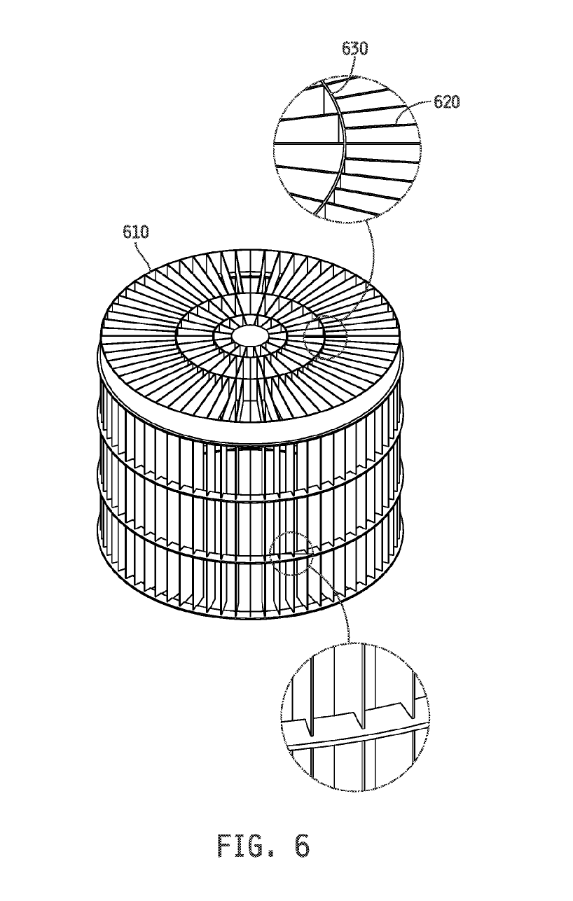

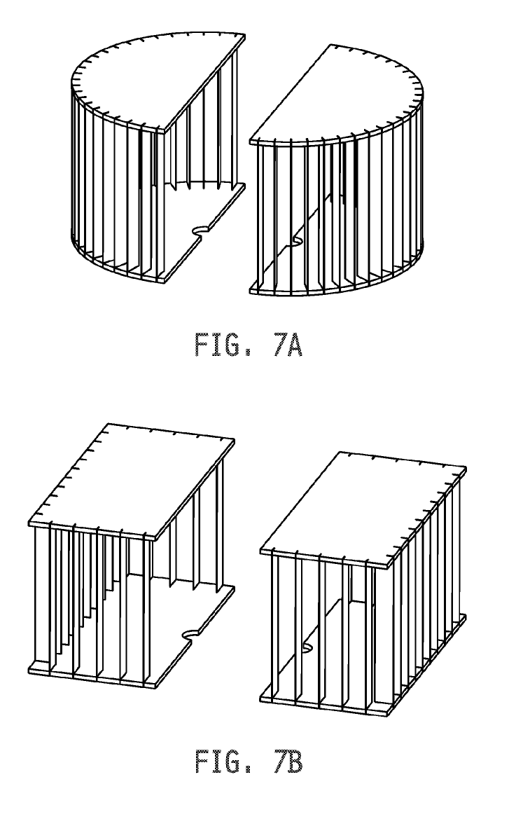

FIG. 6 illustrates a cylindrical cage with a louvered top. As illustrated in FIGS. 2A, 2B, and FIGS. 3A, 3B, when a circular cylindrical or rectangular parallelepiped cage is in the TM010 or TE101 resonant mode, respectively, the induced currents in the top and bottom of the cage are radial. Accordingly, in an embodiment the cage can include top and/or bottom portions constructed as a radial type louver. FIG. 6 shows such a louvered top 610. In the illustrative embodiment, the top comprises a plurality of strips 620 extending radially away from the central axis of the cylinder, reinforced by rings 630. An analogous structure (not shown) can be used for the top and/or bottom of a rectangular cage.

In an embodiment, the cage can include or be disposed within a shiny metal structure configured to serve as a mirror to reflect visible light in a desired direction (not shown).

As shown in FIGS. 7A and 7B, in embodiments the cage may be formed by pieces with a shape defined by at least one plane passing through a central axis of the cage and parallel to it. For example, if the cage forms a structure that is symmetrical about a central axis, the cage may be formed of two parts defined by splitting the structure at a plane parallel to the central axis. Such a split cage may be fabricated easily, may facilitate tuning the structure's resonant frequency, and in the case of a lamp application may facilitate installing or replacing the bulb. When the pieces are joined together, because little or no current flows in a direction normal to the joints so formed, the pieces forming the cage can be separably coupled together, such as by using clamps, bolts, or the like, without incurring undue microwave leakage.

Honeycomb-Type Construction

Microwave leakage in any mesh structure is related at least in part to the thickness of the mesh. A thick mesh provides more effective microwave shielding than a thinner mesh. In addition, a thick mesh provides improved resistance to deterioration and fatigue. However, a thick mesh also increases raw material and other manufacturing costs versus a thinner mesh, which tends to limit the desirable practical thickness of the mesh. However, in some applications, the wall currents may be variable. In such applications, mesh designs other than louvers made of flat parallel strips may be preferred to provide better microwave shielding under the variable conditions.

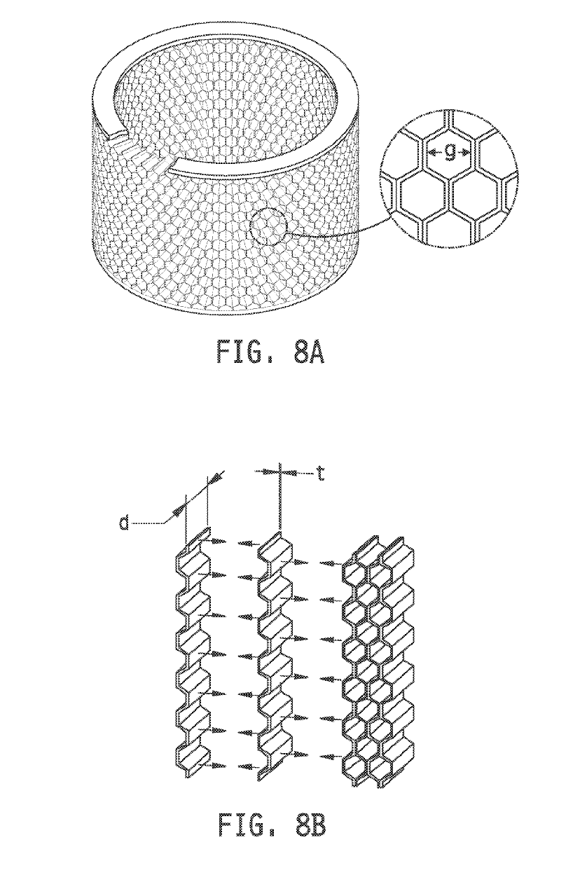

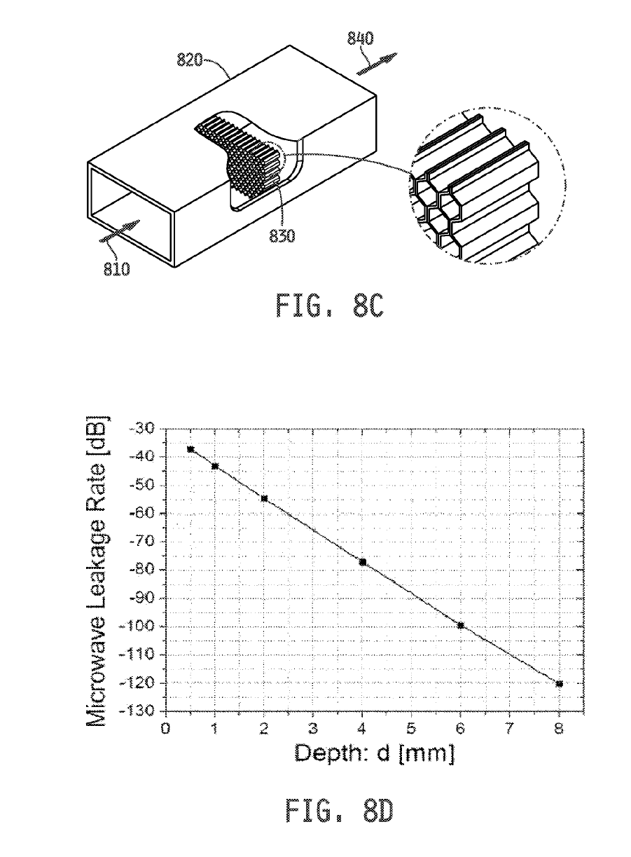

For example, a honeycomb structure may be used for the cavity wall, as shown in FIG. 8A. Such a honeycomb wall can be made of thin metal strips pressed or otherwise bent at regular intervals and at alternating 120 degree angles for example, into the shapes illustrated in FIG. 8B. As shown, the bent strips may be joined together to form a regular hexagonal honeycomb-like structure, such as by soldering, brazing, welding, or the like to ensure good electrical conduction between the elements forming the structure.

When assembled, the width of the bent strips defines the depth of the honeycomb wall. The wall can be made as deep as desired, and may be much greater than the thickness of a conventional prior art mesh having the same size holes, an example of which is shown in FIG. 1A. The microwave shielding effect of the honeycomb structure can again be determined using a waveguide model, as shown in FIG. 8C. In the figure, as before a known amount of microwave energy, 810, is directed into the waveguide, 820. The microwaves pass through the honeycomb structure, 830, which blocks a portion of the microwaves. The remaining unblocked microwaves pass through the rest of the waveguide and are emitted at the other end, 840. The energy of the emitted microwaves can then be measured as various parameters are modified. The microwave leakage rate as a function of the wall depth is graphed in FIG. 8D, keeping constant the thickness of the mesh material and the effective gap distance g between opposite sides of the hexagons forming the honeycomb, as illustrated in FIGS. 8A and 8B.

As can be seen from the graphs of FIGS. 4B and 8D, the microwave shielding of the honeycomb wall is less than that of the louver type wall, other things being equal. Nevertheless, the honeycomb structure may be preferable to the louver structure in some applications. For example the honeycomb structure may be preferred in applications in which wall currents may have arbitrary or variable distributions.

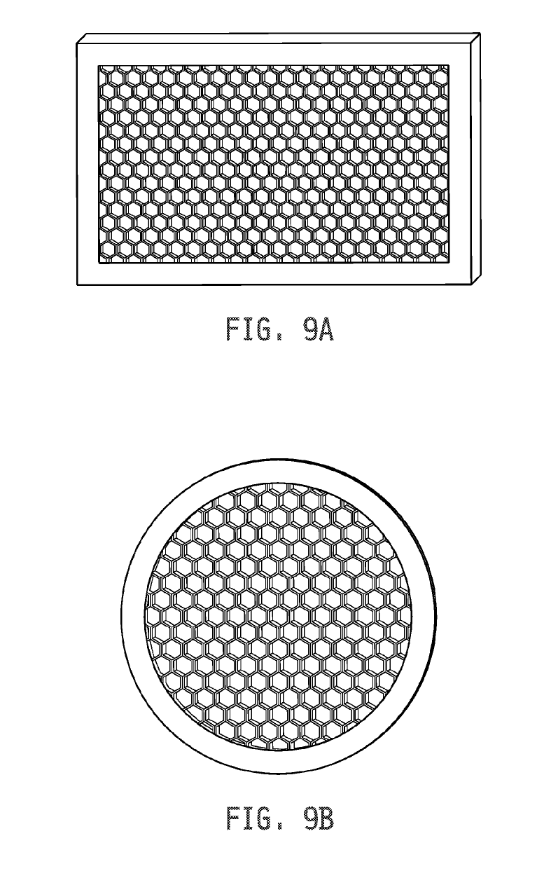

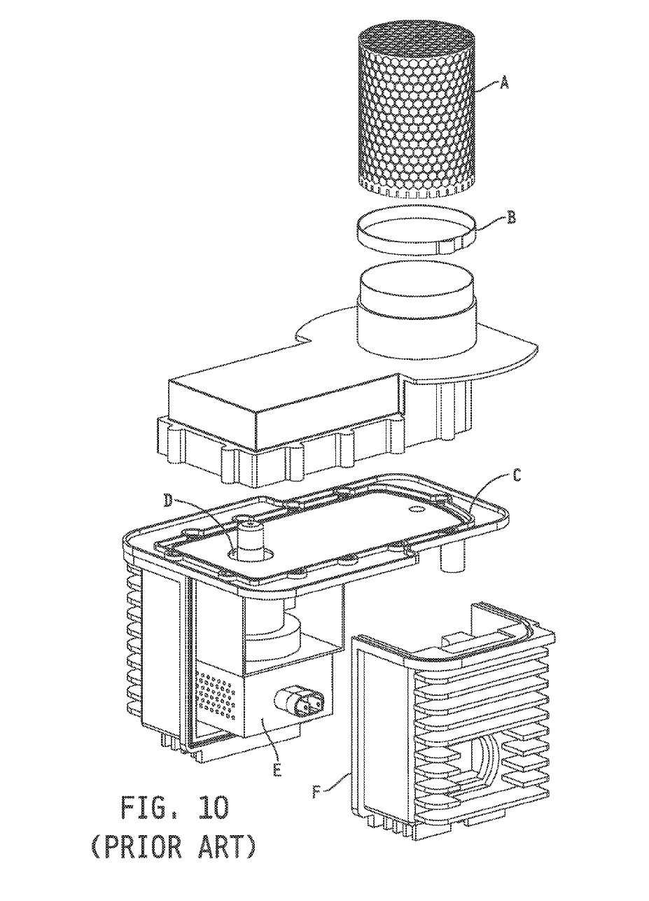

The honeycomb structure's effectiveness regardless of any specific cage wall current distribution allows it to be used in some cases in which the louver type wall cannot be used. For example, the honeycomb structure may be used as a window for a microwave oven or for an industrial microwave applicator. Such a window may have a rectangular shape as shown in FIG. 9A, or a circular shape as shown in FIG. 9B, for example. As can be seen by comparing the graph of FIG. 1C pertaining to the thin wall with a honeycomb mesh used in the prior art, to the graph of FIG. 8D pertaining to the much deeper wall with a similar mesh disclosed herein, the deeper mesh provides a far more effective microwave shield.

Microwaves enclosed in a structure comprising an electrically conductive wall have structure-specific characteristic distributions of the electromagnetic field, which at resonant frequencies are called resonant modes. These modes of resonance induce current flows in the walls of the structure that have specific current distributions. In order to confine the microwaves to the inside of the structure, the wall must comprise a good electricity conducting material such as metal. If there are gaps, holes, or joints with substantial electrical resistance in the wall, microwaves can leak through them. In embodiments, cage and enclosure components can be used to mitigate microwave leakage by choosing appropriate respective component shapes and resonance modes.

Particularly useful modes are the so-called TM010 mode that arises in a circular cylindrical component as illustrated in FIG. 2A, and the TE101 mode that arises in a rectangular parallelepiped component as illustrated in FIG. 2B. The dimensions of each component can be selected so that only the desired mode arises for a given microwave frequency. These modes are desirable because the currents along the side walls of the component induced by the microwaves inside it are all parallel to the central axis of the component. Accordingly, a component can be formed from pieces that, when assembled, form joints aligned with the current flows, so that little or no current flows across the joints and no substantial microwave leakage is incurred.

In an embodiment, a sulfur lamp apparatus is composed of two assemblies, A and B. Each assembly is configured such that a desired resonance mode arises therein from microwaves at the frequency produced by the magnetron. Each assembly is split into pieces along their respective central axes, and the pieces of the assembly are attached together to form a rigid body. The pieces may be fixedly attached, such as by welding, brazing, the like, or they may be removably attached such as by banding or bolting them together. In either case, virtually all of the wall current induced in the assembled pieces by microwaves at the frequency generated by the magnetron can freely conduct without experiencing any substantial contact resistance, because the current through each component flows parallel to the joints formed between its pieces. Consequently, little or no microwave energy is emitted through the joints.

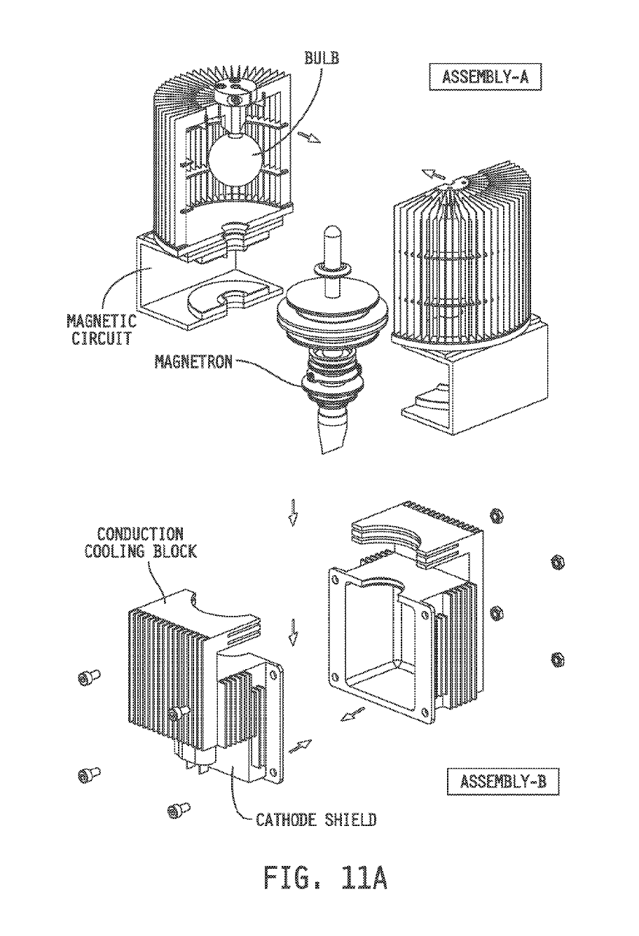

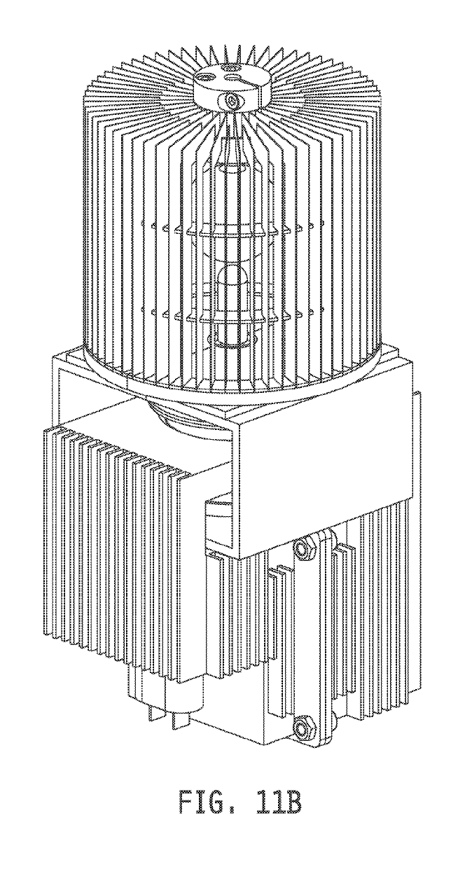

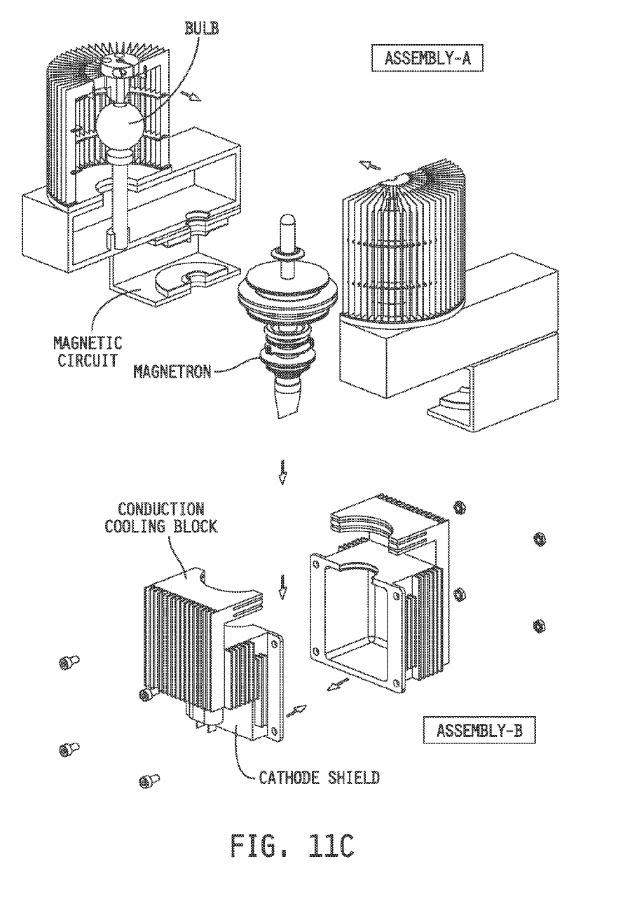

As shown in FIGS. 11A, 11B, and 11C, assembly A encloses the bulb and is removably coupled to the magnetron. In the exemplary embodiment illustrated, the lamp cage comprises two halves joined together, but other numbers of pieces may be used. The two halves of the assembly are joined together with the bulb inside, and an appropriate structure of each half may be matched with a homologous structure of the other half to easily align the halves during assembly. Joining the two halves can be done rather loosely, such as by a simple clamping or bolting mechanism. Because currents are induced in a resonant mode parallel to the joints so formed, no wall currents flow at resonance across the joints and thus no microwave leakage can occur there. Moreover, because both assemblies A and B are formed by a method that can be performed in the field, the bulb or the magnetron can be replaced quite easily if needed.

In the exemplary embodiment illustrated, the magnetron enclosure also comprises two halves joined together, but other numbers of pieces may be used. The two halves of the enclosure are joined together with the magnetron inside, and an appropriate structure of each half may be matched with a homologous structure of the other half to easily align the halves during assembly. Joining the two halves can be done rather loosely, such as by a simple clamping or bolting mechanism. Because currents are induced in a resonant mode parallel to the joints so formed, no wall currents flow at resonance across the joints and thus no microwave leakage can occur there.

In the exemplary embodiments illustrated in FIGS. 11A, 11B, and 11C, Assembly B includes cooling elements to dissipate heat generated by the magnetron, and may also be integrated with the cathode shield cover. Heat conducting cooling fins may be fixedly attached to the outside of the anode, and slidingly coupled to interlacing fins of other cooling elements to form a thermal coupling having a large area of overlap. In embodiments, the split halves of assembly B may be made of aluminum, for example by casting, extruding, or milling, and the pieces may be fixedly attached together, such as by welding or brazing, or they may be removably attached, such as by banding or bolting them together.

In an embodiment, the lamp cage may be a circular cylinder in which the TM010 mode arises as the resonant mode. Therefore, all side wall current is parallel to the axis of the cylinder, and the top and bottom wall currents are in the radial direction, as illustrated in FIG. 2A. Accordingly, the cage can be made with a louver type construction, with all louvers in parallel to the wall currents induced in the TM010 mode. Such a louvered cage provides excellent microwave shielding and good transmission of visible light. The cage can be split into two or more pieces along any vertical plane passing through the length of the axis of the cylinder and still provide good microwave shielding when assembled. In an embodiment, the cage may be split into two pieces, each of which forms substantially half of the assembled cage.

In embodiments, at least two types of couplers may be used to convey microwave energy from the magnetron to the lamp assembly—an antenna coupler, and a waveguide coupler. In either case, to avoid microwave leakage at any joint formed around a hole through which the antenna passes, that joint in particular must be carefully formed to provide an uninterrupted electrical path having low resistivity that provides continuous electrical conduction across the joint, such as by welding together the components on either side of the joint. For example, in the embodiment illustrated in FIG. 11A, in the antenna coupler embodiment the magnetron antenna may be inserted directly into the lamp cavity. As such, the joints formed by coupling the bottom halves of the cage to respective top halves of the magnetic circuit must be carefully formed as just described, such as by welding the respective halves together.

As illustrated in FIG. 11C, in the waveguide coupler embodiment, a rectangular parallelepiped waveguide may be inserted between the microwave assembly and the lamp assembly. In an embodiment, similarly to the magnetron enclosure, the rectangular waveguide may be configured so that the TE101 resonant mode arises at the microwave frequency generated by the magnetron. Therefore, it may again be formed of pieces, such as halves, defined by a plane passing through its central axis, and no substantial wall current will flow across the joint formed by coupling the two halves together. However, the joints formed by coupling the bottom halves of the waveguide to the top halves of the magnetic circuit, that is, around the hole through which the antenna passes, must be carefully formed as previously described, such as by welding respective halves together.

In the exemplary embodiments shown in FIGS. 11A and 11C, assembly A is coupled to assembly B using a magnetic circuit. The magnetic circuit includes two pairs of magnets and two pairs of respective pole pieces, each pair fixedly coupled to a respective flux return that forms a magnetic circuit when the lamp and microwave assemblies are coupled together. The magnetic circuit may thus be split into halves, as shown. In embodiments, the magnets used in the magnetic circuit may also be used to form or support the magnetic field of the magnetron.

In the illustrated embodiments, microwaves are also prevented from leaking out of the magnetron though the cathode leads, which are located on the opposite side of the magnetron from the antenna. Power needed for magnetron operation, such as high voltage heater power, may be fed into the magnetron through a filter circuit. The cathode end and the filter circuit are enclosed in a cathode shield box. In the illustrated embodiment, the shield box is integral to and part of the cooling plate of the conduction cooling system, and the outer surface is grooved to increase the cooling surface area. Alternatively, the shield box may be fixedly or removably coupled to the cooling plate, preferably in a manner that provides a good thermal coupling. The cooling plate may be made of aluminum, and may comprise fins coupled by sliding fit to copper cooling fins attached to the outside surface of the magnetron to dissipate heat from the anode. The shield box, if separately formed and coupled to the cooling block, may similarly be formed of aluminum and may have a grooved surface.

Thus, the disclosed split construction sulfur lamp apparatus comprises a microwave assembly with an enclosure containing a magnetron, and a lamp assembly with a lamp cage containing a sulfur bulb. The enclosure may be integrated with a cathode shield as a composite enclosure. The lamp cage and the composite enclosure may each be formed from two halves formed by the intersection of the respective cage or enclosure with a plane through the length of the cage or enclosure's central axis. The assembled cage and enclosure may be configured to form a shape that resonates at the frequency of the microwaves generated by the magnetron, in a select resonant mode that induces wall currents only parallel to the joints formed by joining the halves together during assembly. The halves may be removably attached together, such as by banding or bolting them together. In addition, a magnetic circuit may be formed from two halves, each of which is fixedly attached, such as by welding or brazing, to a respective half of the assembly and which, when assembled, form a hole through which the antenna will pass. If the antenna is inserted directly into the cage, that assembly comprises the cage. If the antenna is inserted into a waveguide, that assembly comprises the waveguide.

Moreover, in embodiments the halves of the assemblies may be configured in a manner that allows the lamp assembly to be removably coupled the to the microwave assembly. In an embodiment, the assembled magnetic circuit comprises two magnets and two respective pole pieces, each magnet and pole piece fixedly coupled to a respective flux return. The magnets of the magnetic circuit may be or support the magnets that produce the magnetic field of the magnetron. In an embodiment, removably coupling the lamp assembly to the microwave assembly can be realized by configuring the apparatus such that the portion of the cooling block that is thermally coupled to the magnetron anode fins is enclosed within the halves of the magnetic circuit when the apparatus is assembled.

The disclosed sulfur lamp apparatus comprising lamp and microwave assemblies, each formed of halves removably joined together to form respective shapes in which a respective resonant mode arises at the frequency of the microwaves produced by the magnetron, and that induces currents substantially parallel to the joints so formed. The apparatus includes a tight joint around a hole through which the microwave radiating antenna passes, provides a sulfur lamp apparatus that does not produce significant microwave leakage, and provides for easy replacement of the bulb or the magnetron in the field.

Many considerations should be taken into account when designing a sulfur lamp apparatus. For example, a size and shape of the space in a fixture into which the apparatus will be installed can influence the selection of certain components of the apparatus to be sure it will fit in the space allotted. Components subject to being designed, configured, and/or selected from a plurality of alternatives can include, for example, the coupling to use between the lamp and the magnetron, the construction to use for the lamp cage to allow light from the sulfur bulb to shine through while blocking microwaves, and more. In general, the goals are to produce light efficiently, in a desired light dispersion pattern, with minimal microwave leakage.

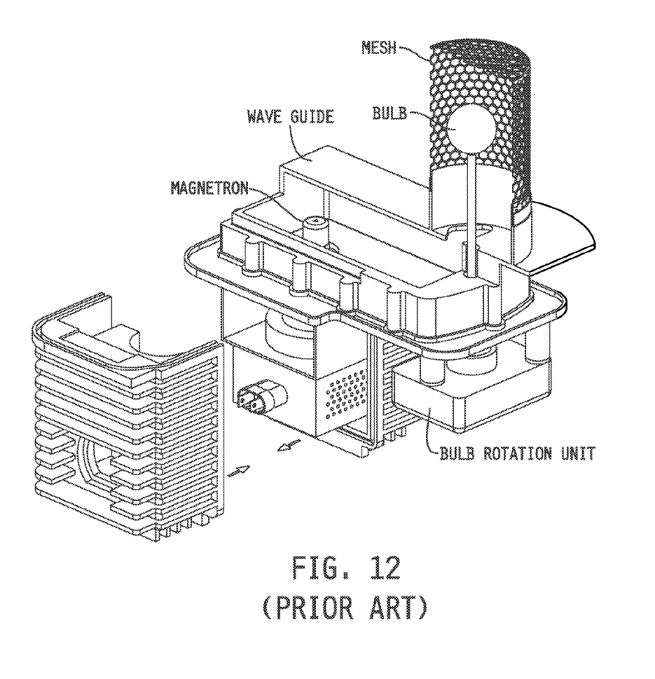

FIG. 12 shows a prior art sulfur lamp apparatus that has many sources of microwave leakage. For example, the thin honeycomb mesh surrounding the bulb does not block a significant portion of the microwaves injected into the space defined by the mesh to cause the bulb to emit visible light. The wave guide is constructed in pieces that are joined in a manner that presents high electrical resistance in the joint to current induced in the walls of the wave guide across the joint. Moreover, the wave guide itself is joined to the lamp mesh with a tightened band, and to the magnetron enclosure using a gasket, both of which similarly allow microwave current to leak through because of the high resistance of the joints. Another undesirable characteristic of prior art sulfur lamps is that they require rotating the bulb during operation as a cooling measure. The bulb is rotated by some type of bulb rotation unit that necessarily has moving parts that are subject to wear and mechanical breakdown that incur maintenance costs. Yet another undesirable aspect of the prior art is that the magnetron, which produces significant heat during operation, is cooled using a fax that is similarly subject to wear and mechanical breakdown, and furthermore can introduce insects, dust, and other particulates into the magnetron, adversely affecting its operation. All of these undesirable characteristics can be remedied by proper design of the apparatus.

Magnetron power is output from the magnetron through an antenna that is operatively coupled to the interior of the lamp cage. The antenna may be configured to have any convenient length and/or any convenient casing. For example, in an embodiment of an exemplary sulfur lamp apparatus adapted for use in street lighting, the antenna may have a rather long, thin shape encased in a ceramic tube terminating in a dome.

It is noted that in simulating the coupler, such as for testing and design purposes, the magnetron may be replaced with a coaxial line having the same impedance characteristics.

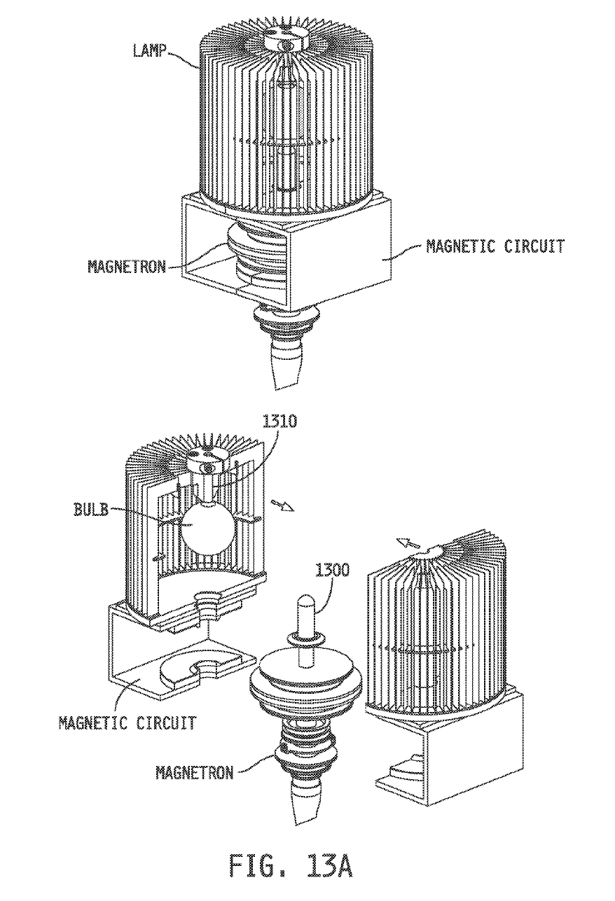

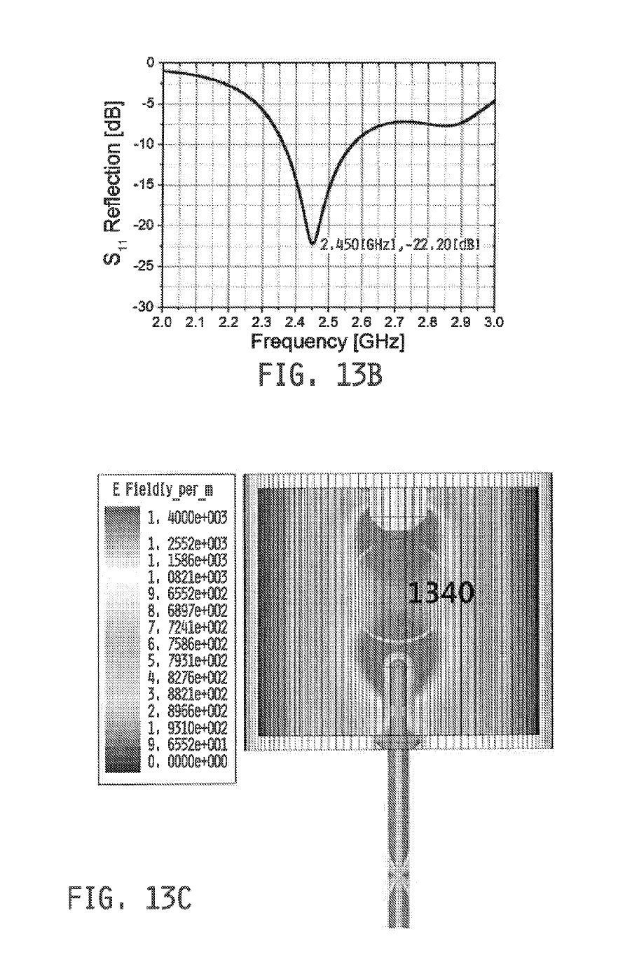

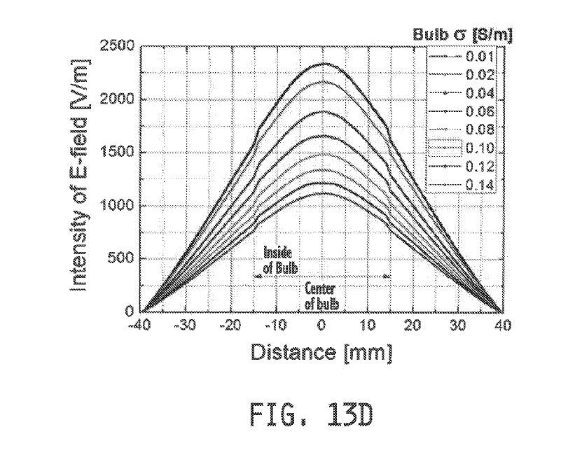

FIG. 13A illustrates an embodiment in which the magnetron antenna 1300 is inserted directly into the lamp cage in a so-called E-coupling. In order to achieve a good frequency match and good field shape, it is preferable to place the antenna along the central axis of the cylinder, and to put a matching post 1310 on the wall of the cavity opposite the antenna. The shape, dimensions, and chamfer of the antenna and/or the matching post can be configured to achieve a desired field shape and TM010 resonant frequency. For example, the matching shown in FIG. 13B can be achieved, with the field distribution shown in FIG. 13C before and after the discharge. Note that the lamp assembly is configured so that better than 99% of the injected microwave power is absorbed by the bulb at its full discharge condition.

The peak field value at the center of the bulb may be calculated as a function of the conductivity σ of the bulb. The conductivity of the bulb increases from zero when the lamp is first turned on, to a peak at the full discharge condition. FIG. 13D shows the conductivity of the bulb increases with increasing field strength at its center. In the figure, the order of resistivity values in the table is in the opposite order of the corresponding curves. That is, the topmost curve corresponds to the bottommost value of bulb σ, 0.14 siemans/meter. FIG. 13D illustrates that the field strength at the bulb during operation is always much higher at the peak than at the starting condition. The bulb contains argon at about 10 mTorr pressure in order to initiate the discharge and induce the full sulfur discharge. FIG. 13D shows the field strength at the bulb throughout the discharge process from argon to sulfur.

This coupler is symmetric about the axis of the lamp cage cylinder, resulting in a field distribution that is also symmetric in the TM010 mode. This symmetry results in an induced current flow on the side wall of the cage that is parallel to the central axis of the cylinder. Because of this property, the side wall of the cage can be formed using louvers in a structure that blocks substantially all microwave leakage from the cage. The advantage of the louver type construction is that it can achieve better than 90% of light transmission while microwave EMI leakage is kept below 120 dB, which is effectively leakage free in most applications.

As noted, because of this property a louver type cage can be formed in halves defined by the intersection of the cage and a plane parallel to and intersecting the cylinder's central axis. The halves may be coupled together by simple clamping or bolting without resulting in substantial EMI due to microwave leakage. This type of construction desirably allows for easy replacement of the bulb. Similar construction of the magnetron casing can also allow for easy replacement of the magnetron.

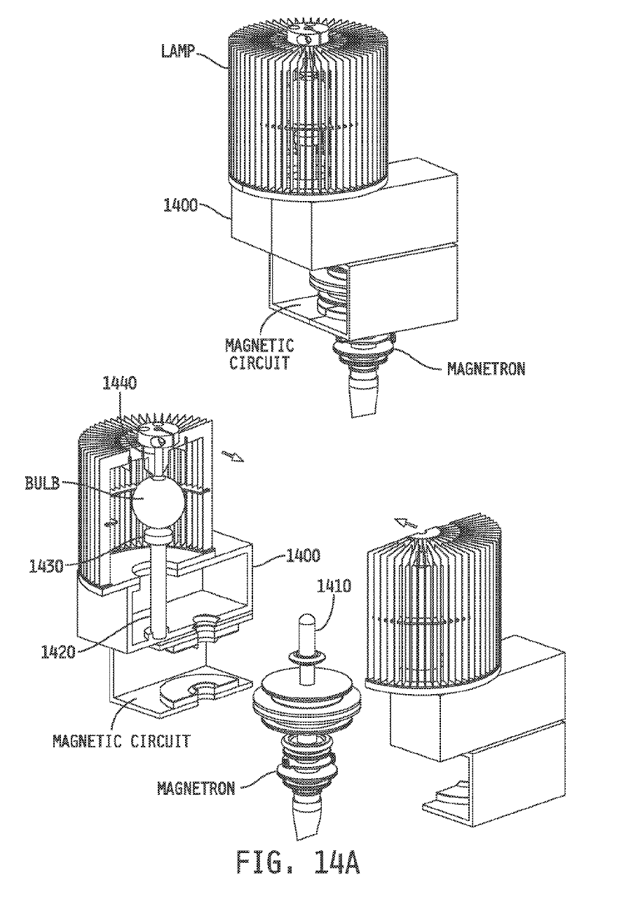

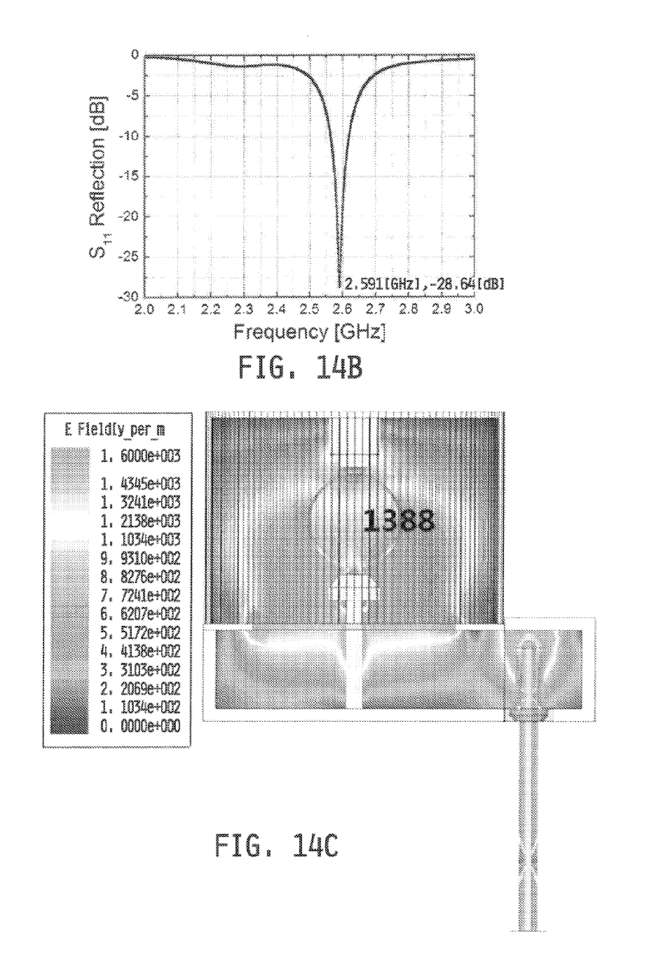

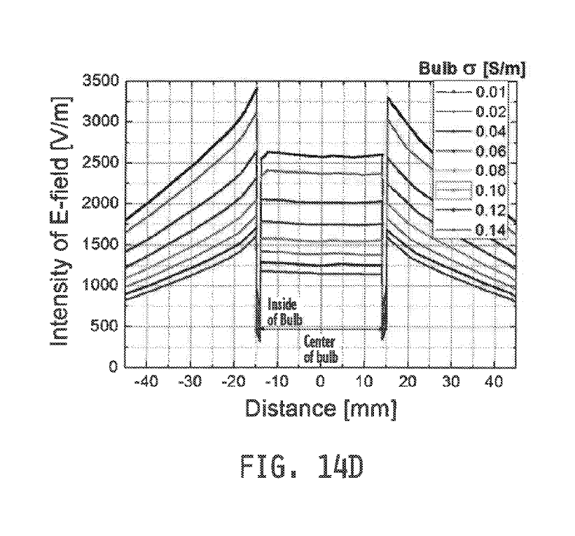

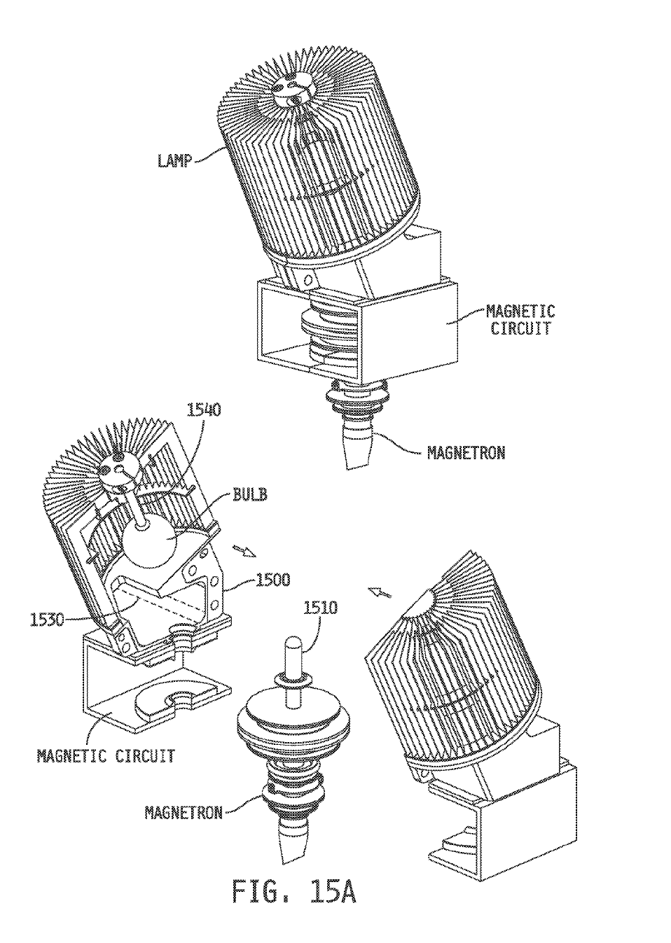

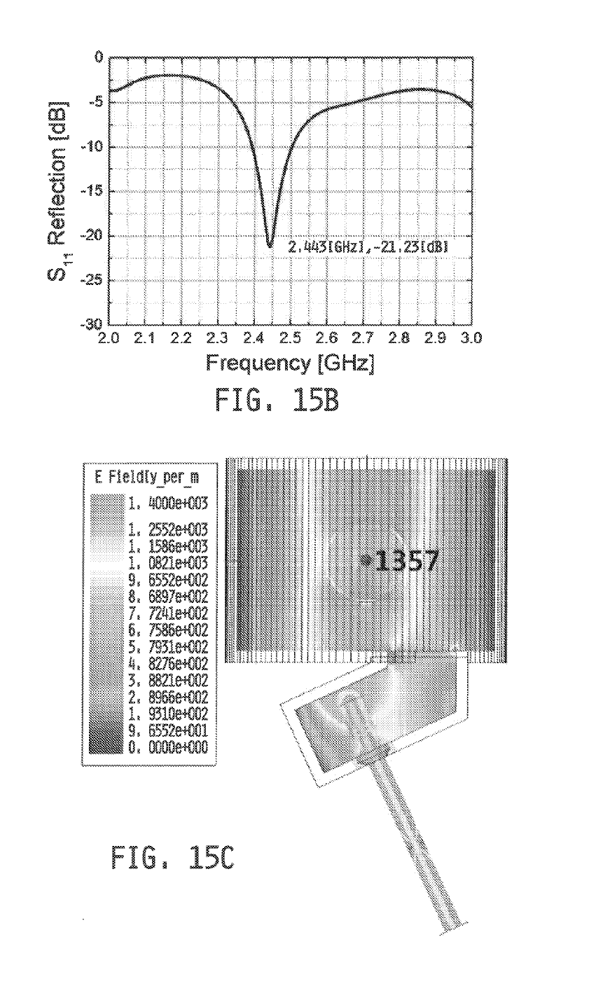

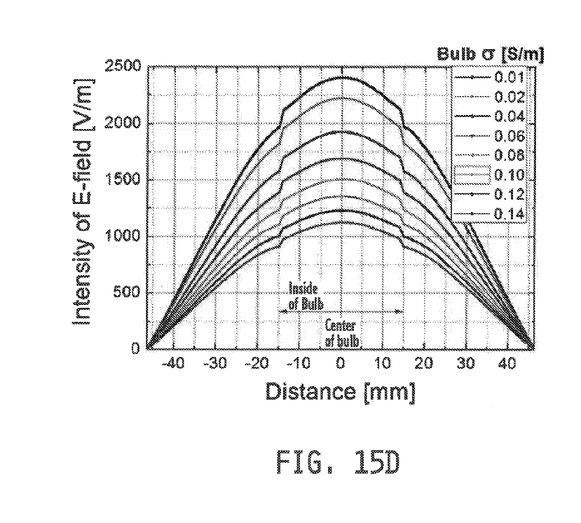

As can be seen by comparing FIG. 13B with FIGS. 14B and 15B, this type of coupler provides the most compact design of the sulfur lamp. As such, a sulfur lamp so designed may be used for lighting applications such as street lighting, because the compact size of the lamp apparatus allows it to fit into existing lighting fixtures without modification for each installation.

FIG. 14A illustrates an arrangement in which the magnetron antenna 1410 is inserted into a short rectangular waveguide 1400 in a so-called post coupling. Near the other end of the waveguide, a long post 1420 is attached so that one end of the post is fixed to the bottom of the waveguide while the other end is inserted into the cylindrical lamp cage, for example, through a circular hole on the top wall of the waveguide. In an embodiment, a circular disk 1430 is attached at the tip of the post to increase the capacitance of the post to allow for good impedance matching of the lamp assembly and the magnetron. The disk can be chamfered for field shaping.

As described previously in connection with the antenna inserted directly into the lamp cage, in order to achieve a good impedance match and good field profile it is preferable to place the end of the post 1420 along the central axis of the lamp cage, and to attach a matching post 1440 on the opposite wall of the cage. By properly selecting the dimensions and chamfer of the matching post, the frequency matching character shown in FIG. 14B can be achieved, with the field distribution shown in FIG. 14C before and after the discharge. Note that the cavity is matched so that better than 99% of the injected microwave power is absorbed by the bulb at its full discharge condition.

As before, the peak field value at the center of the bulb may be calculated as a function of the conductivity o of the bulb. FIG. 14D shows the conductivity of the bulb increasing with increasing field strength at its center. In the figure, the order of resistivity values in the table is in the opposite order of the corresponding curves. That is, the topmost curve corresponds to the bottommost value of bulb σ, 0.14 S/m. FIG. 14D illustrates that the field strength at the bulb during operation is always much higher at the peak than at the starting condition. As before, the bulb contains argon at about 10 mTorr pressure in order to initiate the discharge and induce the full sulfur discharge, and FIG. 14D shows the field strength throughout the discharge process from argon to sulfur.

This coupler is very close to being symmetrical about the axis of the lamp cage cylinder, but it is not quite symmetrical because the central axis of the lamp assembly is offset from the central axis of the magnetron, and is coupled to it via the waveguide. However, because the long post plays the dominant role in shaping the field distribution inside the lamp cage, the field distribution in the cage is very close to being symmetric. This near symmetry, although not perfect, results in an induced current flow on the side wall of the cage that is nearly parallel to the central axis of the cylinder. As such, the side wall of the cage can be formed using louvers, but with caution. The advantage of the louver type cavity is again that one can achieve very good light transmission while the microwave leakage is kept very low.

If a louver type cage is chosen, as before it may be formed in halves defined by the intersection of the cage with a plane through the cylinder's central axis, and coupled together by simple clamping or bolting without incurring substantial EMI due to microwave leakage. As noted, this type of construction allows for easy replacement of the bulb or the magnetron. Here however, in applications in which the EMC is exceedingly important and EMI must be kept as low as possible, a different construction may be preferable in which even less EMI occurs, such as a unibody louver construction, or a unibody honeycomb construction.

Although this type of coupler does not result in a sulfur lamp as compact as one using the antenna coupler, it is still compact enough to fit into some existing lighting fixtures, including street light fixtures. Moreover, this coupler may be preferred in some applications because it can provide a greater ability to impedance match the lamp assembly and the magnetron, and to shape the field distribution.

FIG. 15A illustrates a so-called H-coupler design in which the magnetron antenna 1510 is inserted into a short section of a rectangular wedge-shaped waveguide 1500. The other end of the waveguide is open to the lamp cavity, that is, coupled to the lamp cavity through a coupling hole 1530. This type of coupling is so-called because a magnetic field is denoted by H in the literature, and here the coupling is accomplished between the magnetic fields in the waveguide and the cavity. This type of waveguide can be configured to fit as needed for a particular application, such as in a particular lighting fixture.

In order to use this coupler to match the lamp assembly impedance and to achieve the proper field profile, two matching posts may be disposed inside the cavity. The top post 1540 is effective to concentrate the field at the bulb. A bottom post (not shown) may be used to correct for field distortion at the coupling hole. Without the bottom post, the strongest field may be formed at the coupling hole rather than at the bulb.

By properly selecting the dimensions of the H-coupler, the coupling hole, and the top and bottom matching posts, the matching character shown in FIG. 15B can be achieved, with the field distribution shown in FIG. 15C before and after the discharge. Because there are more parameters to adjust, it can be much more difficult to optimize the design of this type of coupler. A configuration resulting in the field distribution shown in the FIG. 15C is the currently preferred configuration. This field distribution is quite close to being symmetric, but is not perfect. Accordingly, use of this type of coupler in conjunction with a louver type cage construction should be considered with caution. For applications requiring minimal EMI, a unibody and/or honeycomb type construction may be preferred.

FIG. 15D illustrates that the field strength at the bulb during operation is always much higher at the peak than at the starting condition. As before, the bulb contains argon at about 10 mTorr pressure in order to initiate the discharge and induce the full sulfur discharge, and FIG. 15D shows the field strength throughout the discharge process from argon to sulfur.

This coupler is very close to being symmetric about the axis of the lamp cage cylinder, but the symmetry is not perfect because the waveguide and magnetron are not symmetrical about the same axis as the lamp. However, because the antenna post plays the dominant role in shaping the field distribution inside the cavity, the field distribution is very close to symmetric. This symmetry, although not perfect, results in an induced current flow along the side wall of the cage that is nearly parallel to the central axis of the cage. As such, the side wall of the cage can be formed using louvers, but with caution. The advantage of the louver type cavity is again that it provides very good light transmission while keeping the microwave leakage very low. However, in applications in which the EMC is very important, a different construction may be preferred for the side wall of the cage, such as a unibody and/or honeycomb construction.

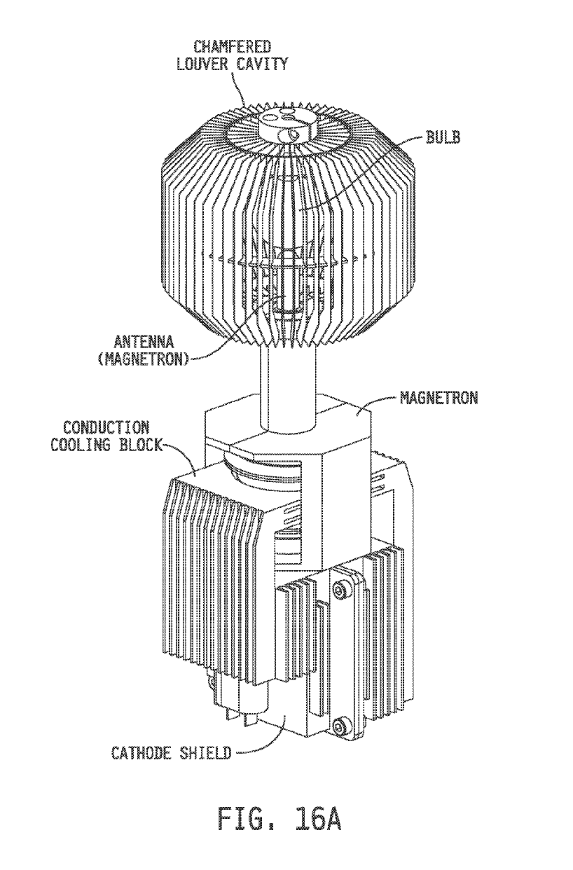

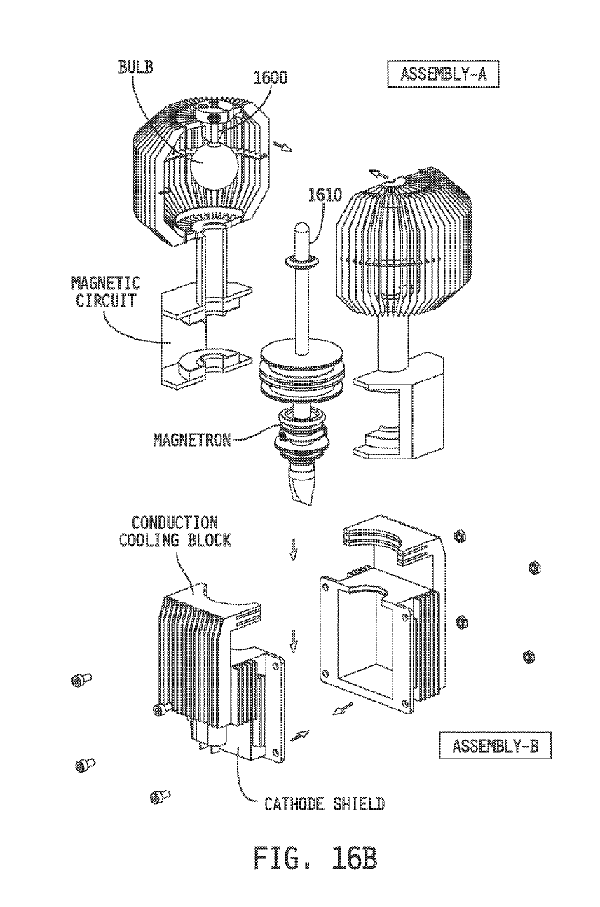

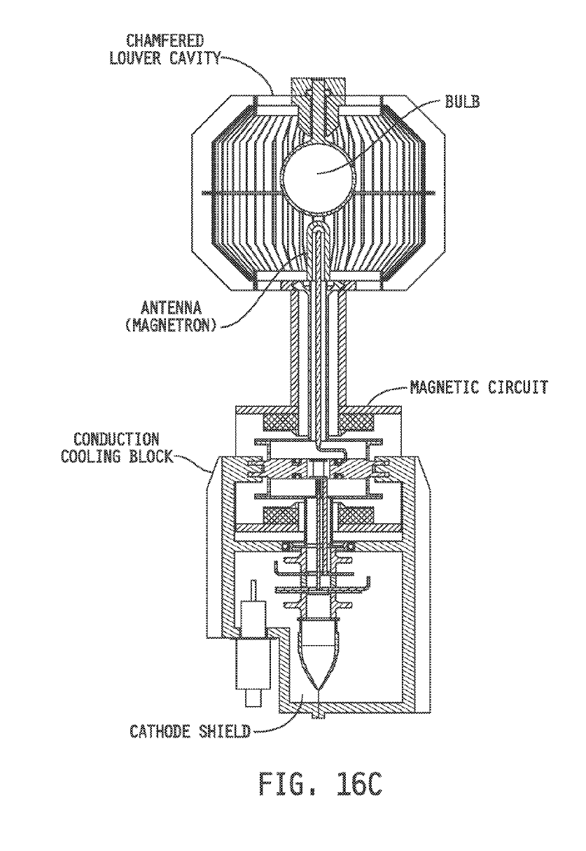

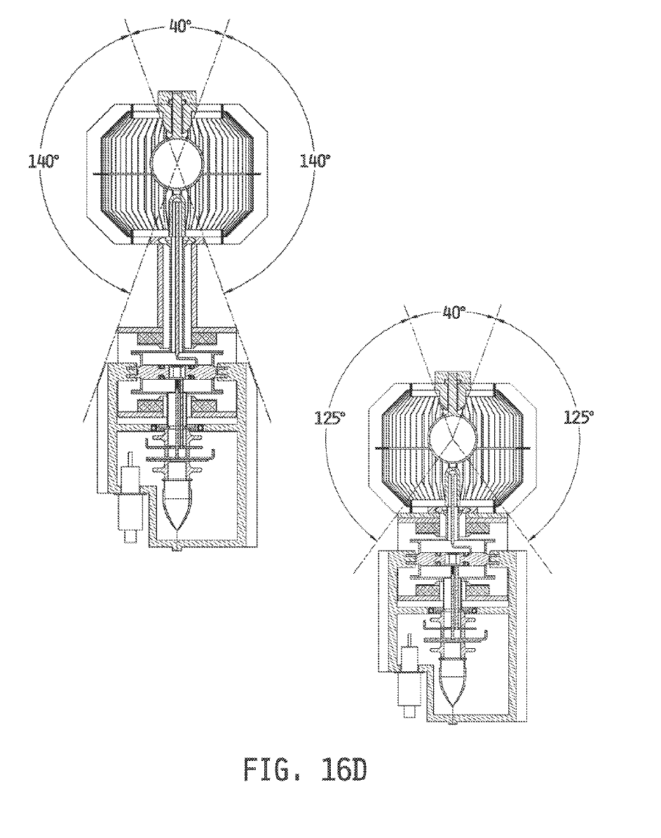

FIG. 16A illustrates an embodiment in which the lamp assembly (Assembly A) comprises a cage configured to define a cavity that resonates in the TM010 mode at the frequency of microwaves generated by the magnetron. FIG. 16B is an exploded view of the apparatus of FIG. 16A. In the embodiment shown, at the center of the top of the cage there is disposed a post 1600 that aids in shaping the microwave field and focusing its energy onto the bulb. The post may also act as or comprise the bulb holder, or the hub for the louver, or both. The bulb may be operated at temperatures far lower than prior art sulfur bulbs. Therefore, unlike prior art sulfur lamps, the bulb need not be rotated, and consequently there is no need to attach a motor to this post. In an embodiment, the post may be configured to cast a shadow of a desired shape from the light produced by the bulb, such as to mimic the shape of the light distribution produced by prior art lamps in particular applications. For example, the post may be thin, and may be configured to be narrower at the tip of the bulb, and the post tip may have a chamfer, for example.

As shown in FIG. 16B, the magnetron antenna 1610 may be inserted directly into the cage through a hole in the center of the cage's bottom wall, where the antenna radiates microwaves directly into the cavity defined by the cage. As illustrated in FIG. 16D, the antenna length may be configured to modify the size of the shadow cast by the antenna and microwave assembly. In particular as shown, the longer the antenna, the smaller the shadow cast by the microwave assembly from the light produced by the bulb. Furthermore, the size of the microwave assembly that blocks light produced by the bulb may be designed to block a preferred amount of the light of the bulb. For example, a narrow microwave assembly will cast a smaller shadow than a wider one, all other considerations being equal. As shown in FIG. 16B, the microwave assembly may in particular include a magnetic circuit and a conduction cooling block, one or both of which may be configured to cast a small shadow from the light of the bulb. Preferably, the length of the antenna and the shape and dimensions of the microwave assembly are jointly configured to produce a light pattern similar to that produced by prior art lamps in the same lighting application.

In the exemplary embodiment shown in FIG. 16B, the lamp assembly (Assembly A) is coupled to the microwave assembly (Assembly B) using a magnetic circuit element. The magnetic circuit includes two pairs of magnets and two respective pairs of pole pieces, one of each pair fixedly attached to a respective flux return. The flux returns are removably joined together, such as by strapping them together, to couple the lamp and microwave assemblies together. As shown, the magnetic circuit may be split into halves each attached to a respective cage half. In embodiments, the magnets used in the magnetic circuit may also form or support the magnetic field of the magnetron.

FIG. 16C shows a cutaway view of the sulfur lamp apparatus shown in FIGS. 16A and 16B, more clearly showing the internal structure of the main components of the assembly.

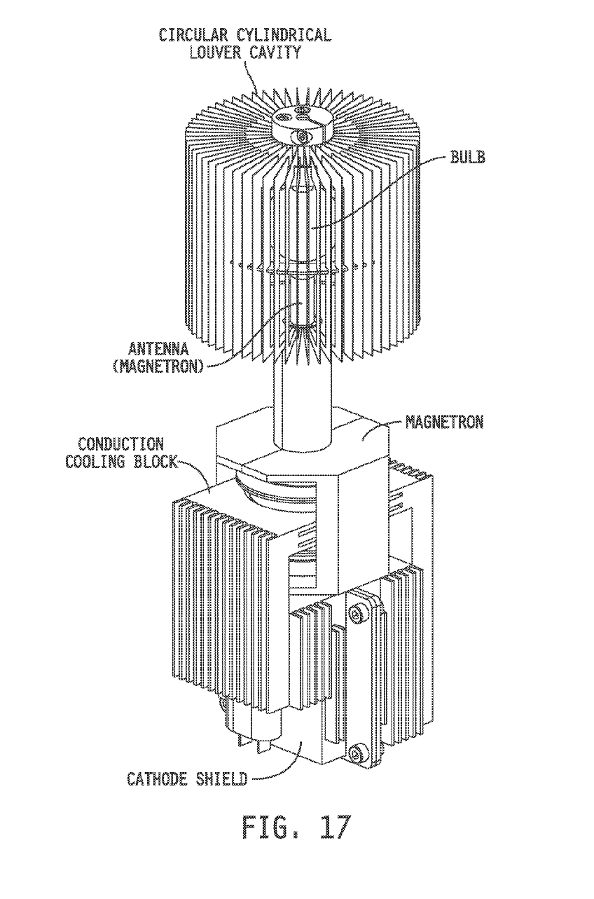

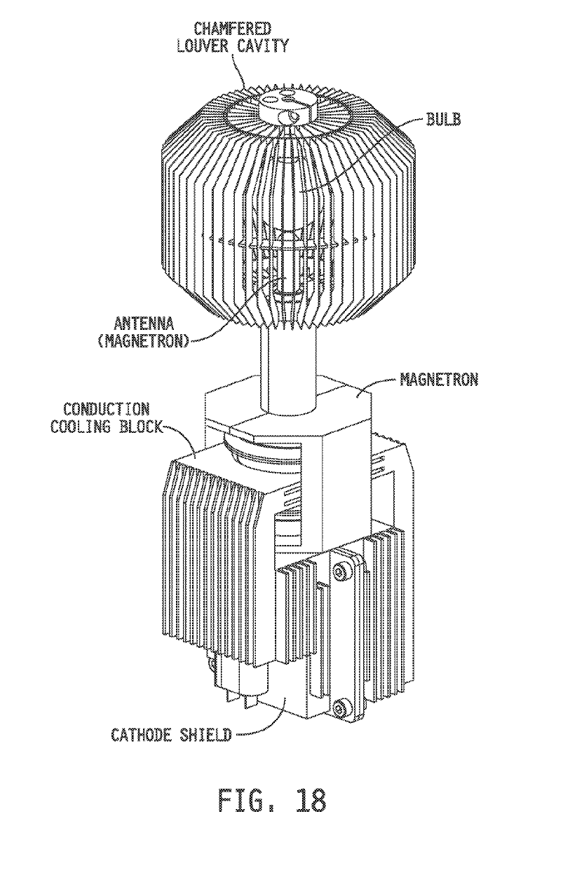

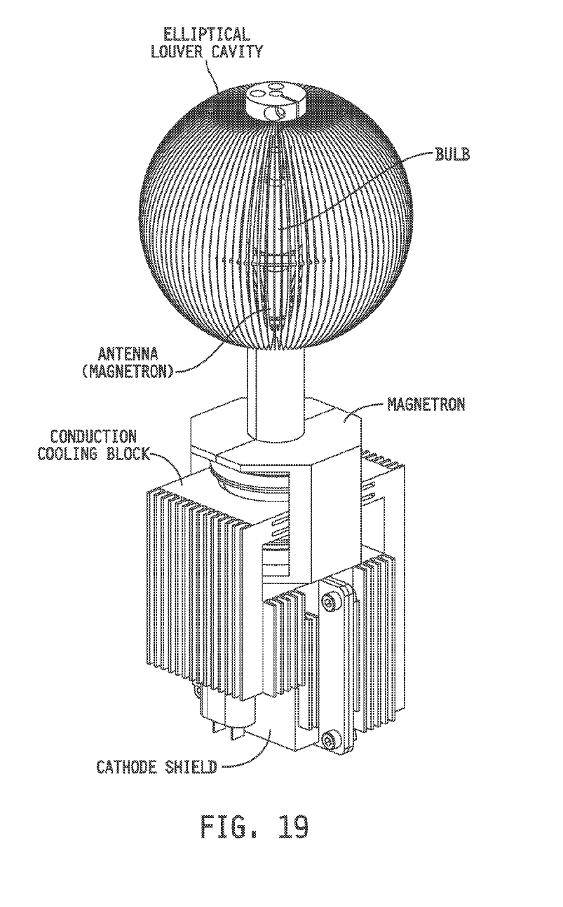

At least three shapes of louver cage may be suitable for embodiments of the lamp. All may be configured to share the common characteristic of defining a cavity resonant in the TM010 mode at the frequency of microwaves generated by the magnetron operatively coupled thereto. FIG. 17 shows a circular cylindrical louver cage, FIG. 18 shows a circular cylindrical louver cage chamfered at the top and bottom sections, and FIG. 19 shows a louver cage in the shape of an ellipsoid, which may be spherical. A cage shape may be selected using criteria such as its visual appeal. For example, the cage illustrated in FIG. 18 may be deemed more visually appealing than that shown in FIG. 17. Regardless of the shape selected, the bulb holder at the center of the top wall and the antenna holder at center of the bottom wall may act as the hubs for the end of the strips forming the louver. In embodiments, one or more ring shaped ribs may be coupled to the louvers to support and align them, as shown in the figures.

Although three particular shapes are illustrated, the invention is not limited to these, but instead can be realized with any cage geometry that induces current flow in a single predictable direction, comprising conductive strips disposed in the same direction, as long as the completed apparatus otherwise has properties suitable for use in a desired lamp application.

The lamp apparatus construction shown in FIG. 16B may be used with any such lamp cage that produces induced currents parallel to the central axis of the cage. That is, the lamp assembly may include a cage constructed in two parts defined by the intersection of the assembly with a plane passing through its central axis. In the illustrated embodiment, each half of the lamp assembly also comprises or is fixedly coupled to half of a magnetic circuit portion which, when assembled, forms a magnetic circuit that provides or supports the magnetic field of the magnetron.

Referring again to the exemplary embodiment shown in FIG. 16B, the microwave assembly (Assembly B) may comprise a magnetron enclosure that includes a conduction cooling block portion and a cathode shield. This enclosure may also be configured to define a cavity that resonates in a mode that induces currents in the enclosure walls parallel to the axis of the enclosure, and as such may also be formed of two halves defined by its intersection with a plane passing through its central axis. For example, for an enclosure substantially in the shape of a rectangular parallelepiped as shown, the enclosure may be designed to resonate in the TE101 mode at the frequency of the microwaves produced by the magnetron. In addition, the lamp assembly and microwave assembly can be configured such that their respective halves may be assembled in a manner that couples the two assemblies together, as shown in FIG. 16A and FIG. 16B.

In embodiments, the lamp assembly, the microwave assembly, and the magnetron may all be configured in combination to meet particular performance and/or regulatory requirements or guidelines needed for particular lighting applications.

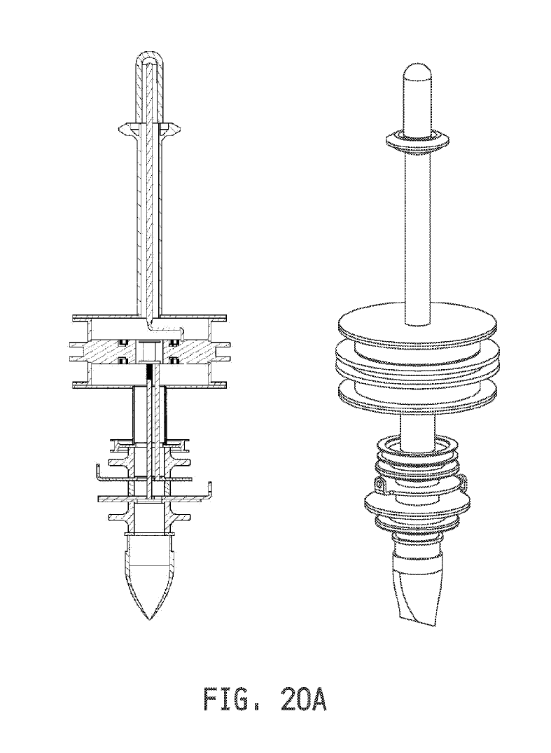

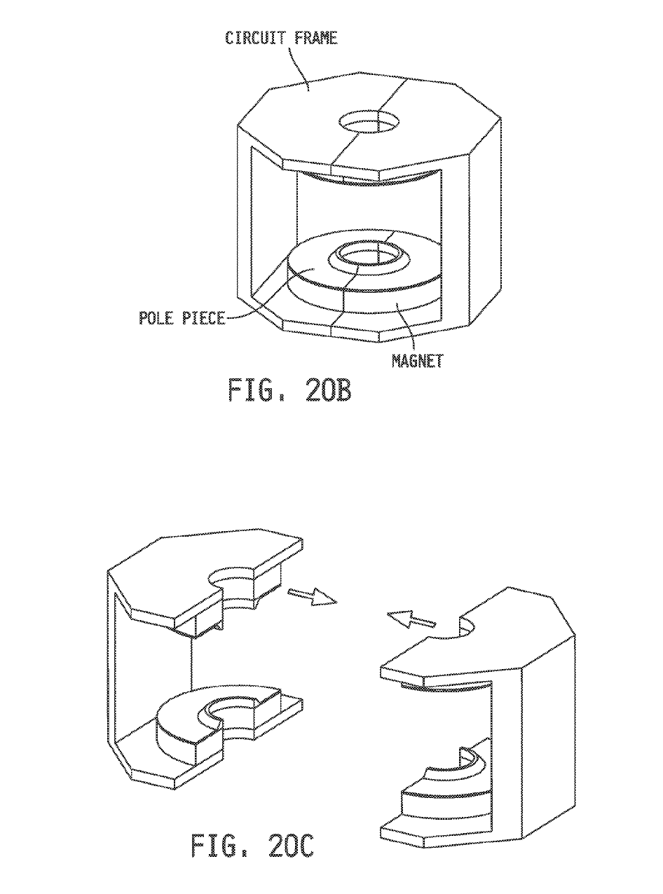

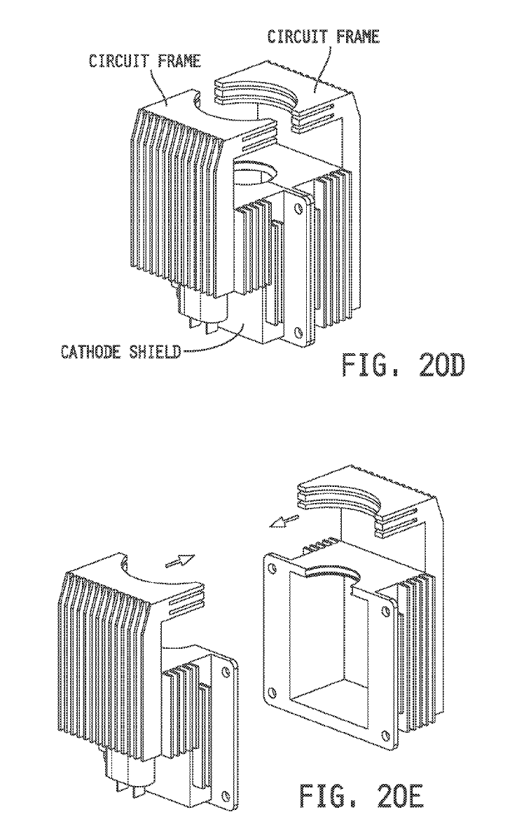

In the magnetron embodiment shown in FIG. 20A, the magnetron antenna has been enclosed within a thin ceramic tube ending in a dome and thus may produce a small shadow in the light produced by the bulb.

In addition, the magnetic circuit and the microwave enclosure including the conduction cooling block may be configured to produce a small shadow from the light produced by the sulfur bulb. In an embodiment, as shown in FIG. 20B, the magnetic circuit may be arranged to present a shape other than a square to the wavefront emitted by the bulb. For example, the figure shows a magnetic circuit that presents an octagonal shape, although other shapes may also be used. FIG. 20C is an exploded view of the magnetic circuit of FIG. 20B.

FIG. 20D shows an enclosure comprising a cooling block configured to produce a small shadow from the light produced by the sulfur bulb. The enclosure is designed to be longer and narrower than other possible configurations, while still providing adequate cooling and shielding properties. FIG. 20E is an exploded view of the cooling block of FIG. 20D. In alternative configurations (not shown), the enclosure may be designed to be wider and/or deeper than that shown, with grooves or fins integral or attached thereto configured by varying their size and/or shape to provide a desired conductive cooling property.

Thus, the disclosed split construction sulfur lamp apparatus configurable for various lighting applications comprises a microwave assembly with an enclosure containing a magnetron, and a lamp assembly with a lamp cage containing a sulfur bulb. The enclosure may be integrated with a cathode shield as a composite enclosure. The lamp assembly and the composite enclosure may each be formed from two halves formed by the intersection of the respective cage or enclosure with a plane through the length of its central axis. The assembled cage and enclosure may be designed to form a shape that resonates at the frequency of the microwaves generated by the magnetron, in a select resonant mode that induces wall currents only parallel to the joints formed by joining the halves together during assembly. The halves may be removably attached together, such as by banding or bolting them together. In addition, a magnetic circuit may be formed in halves each fixedly attached to a respective half of the cage. The halves of the assemblies and magnetic circuit may be joined together in a manner that removably couples the lamp assembly to the microwave assembly. The magnetic circuit comprises two pairs of magnet halves and two pairs of respective pole piece halves, each magnet half and pole piece half fixedly attached to a respective flux return element. In an embodiment, the magnets of the magnetic circuit may be or support the magnets that produce the magnetic field of the magnetron.

The lamp cage, magnetron antenna, magnetic circuit, and magnetron enclosure can be configured together to form a sulfur lamp apparatus suitable for a particular lighting use that may be compact enough for installation in existing lighting fixtures and produce light with similar distribution patterns without substantial modification of the fixtures. The sulfur lamps have a luminous efficacy at least on the order of prior art lamps, generally with a much longer nominal life during which it requires little or no maintenance, and a color rendering and color temperature more closely approximating that of sunlight than prior art lamps. Moreover, these characteristics are all obtained without producing any significant microwave leakage or other new undesirable effects.

Although the invention has been described and illustrated in exemplary forms with a certain degree of particularity, it is noted that the description and illustrations have been made by way of example only. Numerous changes in the details of construction, and the combination and/or arrangement of parts and steps may be made. Accordingly, such changes are intended to be included in the invention, the scope of which is defined by the appended claims.

What is claimed is:

1. A wall apparatus that blocks microwaves and allows visible light to pass through, comprising:
a structure made of a plurality of electrically conductive strips, each strip having:
a first surface and a second surface, wherein the distance between the first and second surfaces defines a thickness of the strip, and
an inside edge and an outside edge wherein the distance between the inside edge and the outside edge defines a depth of the strip that is greater than the thickness of the strip,
wherein the structure formed by the strips defines the wall;
wherein the wall is exposed on one side to both a visible light source and a microwave source;
wherein at least a portion of the strips are arranged so that their first and second surfaces are substantially parallel to rays of visible light emitted by the light source; and
wherein at least a portion of the strips are configured and arranged to have a thickness, depth, and gap width between adjacent strips sufficient to attenuate microwaves emitted by the microwave source passing between the strips by a select amount.

2. The apparatus of claim 1, wherein the wall is configured to form one of a window and a cage.

3. The apparatus of claim 2, wherein the window is a window of a microwave oven.

4. The apparatus of claim 2, wherein the cage defines a cavity of a sulfur lamp that contains the bulb of the lamp.

5. The apparatus of claim 4, wherein the cage has a top and a bottom and is in the shape of one of a circular cylinder and a rectangular parallelepiped, having dimensions that form a cavity resonant in the TM010 mode and the TE101 mode, respectively, from microwaves emitted by a microwave source disposed therein.

6. The apparatus of claim 5, wherein at least one of the top and the bottom of the cage comprises a continuous flat surface.

7. The apparatus of claim 5, wherein at least one of the top and the bottom of the cage comprises a plurality of strips arranged radially from its center to its periphery.

8. The apparatus of claim 4, wherein the cage is symmetrical about a central axis and comprises at least two pieces defined by the intersection of the cage with at least one plane passing through the axis and parallel to it.

9. The apparatus of claim 8, further comprising at least one fastener for separably fastening the pieces together.

10. The apparatus of claim 1, wherein the strips are flat.

11. The apparatus of claim 1, wherein the strips comprise sections disposed at an angle of 120 degrees to each other and arranged to form a hexagonal honeycomb mesh when the strips are arranged adjacent to each other.

13. The apparatus of claim 11, wherein the strips are fixedly joined together to form the honeycomb mesh to ensure good electrical conduction between the strips forming the mesh.

14. The apparatus of claim 12, wherein the strips are joined together by at least one of soldering, brazing, and welding.

15. The apparatus of claim 1, wherein the strips have a thickness between 0.05 mm and 0.3 mm, a gap between strips of between 1.0 mm and 3.0 mm, and a depth of the strips of between 1.0 mm and 10.0 mm.

16. The apparatus of claim 1, wherein the strips have a thickness of about 0.1 mm, a gap between strips of about 2.0 mm, and a depth of the strips of about 8.0 mm.

17. The apparatus of claim 1, further comprising at least one second strip joined at an angle to at least a portion of the strips to strengthen the structure and maintain the spacing between the strips.

18. A sulfur lamp apparatus having low microwave leakage containing a sulfur bulb operatively coupled to a magnetron, comprising:
a lamp assembly containing the sulfur bulb and a microwave assembly containing the magnetron, each assembly formed from respective halves removably joined together and configured to be resonant at the microwave frequency generated by the magnetron in a mode that induces wall currents parallel to the joints formed by joining the halves together.

19. The apparatus of claim 18, wherein:
the lamp assembly comprises a lamp cage in the shape of a right circular cylinder configured to be resonant in the TM010 mode at the microwave frequency generated by the magnetron; and
the microwave assembly comprises a magnetron enclosure in the shape of a rectangular parallelepiped configured to be resonant in a TE101 mode at the microwave frequency generated by the magnetron.

20. The apparatus of claim 19, wherein:
the lamp cage comprises a plurality of conductive strips arranged to form a structure that defines the right circular cylinder, and configured to block microwave energy generated by the magnetron while allowing visible light produced by the sulfur bulb to shine through, wherein the strips are disposed with their surfaces substantially parallel to rays of visible light emitted by the sulfur bulb; and
the magnetron enclosure comprises walls that include solid conductive surfaces arranged to form a structure defining the rectangular parallelepiped.

21. The apparatus of claim 20, wherein:
the lamp cage and the magnetron enclosure each have a respective shape and comprise two respective pieces, each piece forming about half of the respective shape defined by a plane parallel to and passing through the central axis of the respective shape.

22. The apparatus of claim 18, wherein the first assembly is removably coupled to the second assembly.

23. The apparatus of claim 22, wherein the lamp assembly is removably coupled to the microwave assembly by a magnetic circuit comprising at least two magnets, each magnet fixedly attached to a pole piece, each pole piece fixedly attached to exactly one piece of one of the lamp assembly and the microwave assembly.

24. The apparatus of claim 18, wherein the lamp assembly is coupled to the microwave assembly by a coupling in which the magnetron antenna is inserted into the lamp cage and radiates microwave energy directly into the lamp cage.

25. The apparatus of claim 18, wherein the lamp assembly is coupled to the microwave assembly by a coupling that comprises a waveguide that conveys microwave energy from the magnetron to the inside of the lamp cage.

26. The apparatus of claim 25, wherein the waveguide is formed from pieces removably joined together and configured to be resonant at the microwave frequency generated by the magnetron in a mode that induces wall currents parallel to the joints formed by joining the halves together.

27. The apparatus of claim 26, wherein each of the pieces of the waveguide is fixedly joined to a respective half of the lamp assembly.

28. The apparatus of claim 18, wherein the sulfur bulb is a select one of a plurality of available sulfur bulbs that cause the cavity defined by the lamp cage to resonate at different frequencies, wherein the sulfur bulb is selected that causes the resonant frequency of the lamp assembly to most closely match the frequency generated by the magnetron.

29. A method of designing a sulfur lamp apparatus that has a microwave assembly including a magnetron disposed in a case and a microwave antenna coupled to an anode of the magnetron and extending through a hole in the case, and a lamp assembly including a sulfur bulb disposed in a lamp cage the interior of which defines a cavity, and a coupling arranged to couple the microwave assembly to the lamp assembly and to operatively couple the magnetron and the sulfur bulb by conveying microwave power from the magnetron to the sulfur bulb, the method comprising:
defining requirements for a lighting application, including:
determining a size and shape of the space into which the sulfur lamp apparatus will be installed; and
determining a sensitivity of the lighting application to electromagnetic compatibility (EMC) between the lamp apparatus and the surrounding environment; and
designing the lamp apparatus to satisfy the requirements, including:
selecting one of a plurality of available lamp cage construction types; and
selecting one of a plurality of available types of couplings.

30. The method of claim 29, wherein the plurality of available lamp cage construction types include a louver-type construction and a honeycomb-type construction.

31. The method of claim 29, wherein the plurality of available lamp cage construction types include a unibody construction and a split body construction comprising pieces defined by the intersection of the cage with at least one plane passing through a central axis of the cage parallel to the axis.

32. The method of claim 29, wherein the plurality of available types of couplings includes an antenna attached to an anode of the magnetron that extends therefrom in a configuration that is one of:
directly into the lamp cage, wherein a surface of the microwave assembly is coupled to the lamp assembly;
into a waveguide in the shape of a rectangular parallelepiped, wherein the antenna extends into the waveguide through a hole in a surface of the waveguide coupled to the microwave assembly and disposed near a first end of the waveguide, and wherein a post is attached near a second end of the waveguide and extends into the lamp assembly through a hole in a surface of the waveguide attached to the lamp assembly; and
into a waveguide in the shape of a wedge with a rectangular base through a hole in a surface of the base that is attached to the microwave assembly and wherein, on a surface of the wedge attached to the lamp assembly opposite the base, a hole is disposed that is open to the interior of the lamp assembly.

33. The method of claim 29, further comprising:
in the defining the requirements for a lighting application, further including:
determining an acceptable degree of frequency matching between the TM010 mode of the lamp cavity and the frequency of microwaves generated by the magnetron;
determining an acceptable degree of impedance matching between the lamp assembly and the magnetron; and
determining a preferred shape of the field distribution within the lamp cage; and
in the designing of the sulfur lamp to satisfy the requirements, further including:
configuring a microwave radiative element inserted into the lamp cage;
configuring a first post attached to a side of the lamp cage opposite the microwave radiative element; and
in the case an H-coupling is selected, configuring a second post attached to a side of the lamp cage opposite the first post.

34. The method of claim 33, wherein the configuring of at least one of the radiative element, the first post, and the second post as a respective component comprises:
selecting a length, cross sectional shape, thickness, and chamfer of the respective component;
selecting a shape of the end of the respective component;
determining whether to attach an additional element to and end of the respective component; and
in the case an additional element is attached to the end of the respective component, determining a shape, dimensions, and chamfer of the element.

35. The method of claim 34, wherein the additional element added to the end of the respective component is in the form of a chamfered circular disk attached to the end of the respective component at the center of a surface of the disk.

36. A sulfur lamp apparatus for use in street lighting, comprising:
a microwave assembly including:
a magnetron;
a magnetron enclosure surrounding the magnetron; and
a microwave antenna coupled to an anode of the magnetron and extending through a hole in the enclosure;
a lamp assembly including:
a sulfur bulb;
a lamp cage the interior of which defines a cavity into which the sulfur bulb is placed, and
a coupling arranged to couple the microwave assembly to the lamp assembly and to operatively couple the magnetron and the sulfur bulb by conveying microwave power from the magnetron to the sulfur bulb.

37. The apparatus of claim 36, wherein the lamp cage is configured so that the cavity resonates in mode that induces current flow in the cage at least mostly parallel to a central axis of the cage.

38. The apparatus of claim 37, wherein at least a portion of the lamp cage is in the shape of a right circular cylinder, and the cavity resonates in the TM010 mode at the frequency of the microwaves generated by the magnetron.

39. The apparatus of claim 38, wherein the lamp cage is in the shape of a chamfered cylinder.

40. The apparatus of claim 37, wherein the lamp cage comprises a side wall made of louvers constructed using electrically conductive strips, each strip extending in a single flat piece radially from a center of the top of the cage to a portion of the side of the cage in parallel with adjacent strips and radially to a center of the bottom of the cage.

41. The apparatus of claim 40, further comprising:
a bulb holder attached to the bulb and to the center of the top wall;
wherein the antenna is disposed through a hole at the center of the bottom wall, wherein the bulb holder and the antenna may also serve as hubs attached to respective ends of the louver strips.

42. The apparatus of claim 40, further comprising at least one ring shaped rib that supports and aligns the louver strips.

43. The apparatus of claim 37, wherein the lamp cage comprises a honeycomb structure.

44. The apparatus of claim 37, wherein the lamp cage comprises a unibody construction.

45. The apparatus of claim 37, wherein the lamp cage is constructed of pieces defined by the intersection of the finished cage with at least one plane passing through a central axis of the cage parallel to the axis.

46. The apparatus of claim 37, wherein at least a portion the lamp cage has the shape of an ellipsoid.

47. The apparatus of claim 36, wherein the antenna is enclosed within a thin ceramic shell.

48. The apparatus of claim 47, wherein the end of the shell forms a dome.

49. The apparatus of claim 48, wherein the antenna and ceramic shell are elongated to increase the height of the lamp apparatus.

50. The apparatus of claim 36, wherein the magnetron enclosure comprises a magnetic circuit.

51. The apparatus of claim 50, wherein the magnetic circuit is arranged to couple portions of the magnetron enclosure together.

52. The apparatus of claim 36, wherein the magnetron enclosure comprises:
two pieces removably coupled together to form a conduction cooling block; and
a cooling pathway that includes the conduction cooling block.

53. The apparatus of claim 52, wherein the cooling pathway begins at edges of fins inside of a magnetron anode disposed near the cathode and heated thereby, through the body of the fins to a central heat conducting portion of an outside wall of the anode, thence through a plurality of thick heat conducting plates fixedly attached to the heat conducting portion of the anode, thence through at least one fin of the conduction cooling block interlaced with and slidingly coupled to the plates, thence through a body of the cooling block to a plurality of grooves disposed on a surface of the cooling block exposed to the atmosphere, thence to the atmosphere.

54. The apparatus of claim 36, wherein the magnetron enclosure comprises or is fixedly coupled to a cathode shield that blocks microwaves.

55. The apparatus of claim 50, wherein a flux return of the magnetic circuit comprises at least one iron bar fixedly attached to a piece of the magnetron enclosure.

56. The apparatus of claim 36, wherein the magnetron enclosure and antenna are configured to provide a narrow profile to light emitted by the bulb during operation.
